(19) United States
(12) Patent Application Publication
(10) Pub. No.: US 2001/0028707 A1
(43) Pub. Date: Oct. 11, 2001

(54) Communication control method for notifying calling telephone number, terminal device and recording medium

(76) Inventors: Toshihiro Azami, Kawasaki (JP); Katsutoshi Yano, Kawasaki (JP); Tomoyoshi Takebayashi, Kawasaki (JP); Yasuo Sato, Kawasaki (JP); Tomoharu Matsushita, Kawasaki (JP); Shigeki Yamamoto, Kawasaki (JP); Tomonori Yasumoto, Kawasaki (JP)

Correspondence Address: STAAS & HALSEY LLP, 700 11TH STREET, NW, SUITE 500, WASHINGTON, DC, 20001, US

(21) Appl. No.: 09/776,833

(22) Filed: Feb. 6, 2001

Related U.S. Application Data
(63) Continuation of application No. PCT/JP99/04045, filed on Jul. 28, 1999.

(30) Foreign Application Priority Data
Aug. 7, 1998 (JP) 10-224969
Oct. 29, 1998 (JP) 10-308116

(51) Int. Cl. H04M 11/00; H04M 15/06

(52) U.S. Cl. 379/142.12; 379/93.23

(57) ABSTRACT

A communication control method for preventing contention for an originating telephone number among a plurality of terminal devices. A terminal device (3) directly connected with a telephone line is provided with means (11) for setting whether or not to execute an originating telephone number receiving sequence at the terminal device (3) and, when the execution of the originating telephone number receiving sequence is set for the terminal device (3), the sequence is executed at the device (3) and a connection between the telephone line (5) and the other terminal device (4) is cut off; when the execution of the sequence is not set for the device (3), the sequence is not executed at the device (3) and the other terminal device (4) is connected with the telephone line (5) to execute the sequence at the connected other device (4).

### FIELD OF THE INVENTION

The present invention relates to a communication control method for notifying a calling telephone number, a terminal device and a recording medium. Especially, the present invention is used so that plural terminal devices that are connected to a telephone line can receive a call including a notice of a calling telephone number from the telephone line without a contention and is harnessed to a modem that supports a calling telephone number notifying service.

### DESCRIPTION OF THE PRIOR ART

In recent years, a calling telephone number notifying service (i.e., a caller ID service) that enables notifying a receiver side of a caller's telephone number is becoming widely available as one of services of a telephone company. In addition, a combination of a telephone and a computer has realized various telephony services such as automatic calling, answering or displaying a telephone number. Along with these services, a so-called computer telephony is becoming widely available, in which a telephone is connected to a line via a modem and the modem is controlled by a personal computer so as to execute a telephony process. In this situation, the usability of a telephone should be maintained.

When connecting a telephone and a data processing device (a computer) to a common telephone line so as to use them selectively, the telephone is connected with the telephone line directly via a communication line in a communication control device for a normal calling, so that the telephone receives a signal from the telephone line directly.

Therefore, when the communication control device that supports the above-mentioned caller ID service receives a notifying signal of a calling telephone number from the telephone line, the communication control device executes a calling telephone number reception sequence, in which a calling telephone number obtaining process is executed. However, if the telephone that is connected to the telephone line also supports the caller ID service, the telephone also executes the calling telephone number reception sequence. As a result, a contention for obtaining the calling telephone number occurs between the communication control device and the telephone, so that the calling telephone number cannot be displayed correctly.

In addition, if the telephone that is connected to the telephone line does not support the caller ID service, the telephone may ring after mistaking the calling telephone number notifying signal as a calling signal since the calling telephone number notifying signal has the same electrical characteristics as the calling signal. Therefore, if an off-hook operation is done before completing the calling telephone number reception, the normal connection in the communication may fail.

Furthermore, a modem that is used for the computer telephony is controlled by commands from a computer or by a CPU that is built in the modem itself. If a plurality of telephones is connected to the modem, each telephone may generate a response signal that can conflict with other response signals, when the modem receives a call with calling telephone number information.

Therefore, it is considered that the telephone is normally disconnected from the telephone line, and the computer receives the calling telephone number information. In this case, however, the telephone that is connected to the modem cannot be used for calling. In addition, if the computer enters a power-saving mode while the modem is controlled by the computer connected thereto, the application becomes disabled. Since the telephone is disconnected from the telephone line, a call cannot be received.

As explained above, there is a task for a communication control device such as a modem to maintain a good usability of telephones that are connected thereto by controlling the telephones.

In addition, only one terminal device can execute the calling telephone number reception sequence for one telephone line securely as explained above. Therefore, even if a plurality of terminal devices is connected to one telephone line, only one of them can obtain the calling telephone number.

For example, it is supposed that a telephone line is connected to a communication control device that supports the caller ID service, the communication control device is connected to a telephone that supports the caller ID service, and a calling telephone number reception sequence is executed between the telephone line and the communication control device. In this case, even if a telephone is connected after the execution of the calling telephone number reception sequence, the telephone cannot execute the calling telephone number reception sequence. Therefore, the telephone cannot display the calling telephone number. Accordingly, even if the telephone supports the caller ID service, the function of the telephone cannot be used.

### SUMMARY OF THE INVENTION

The present invention is to solve the above-mentioned problem, and the object thereof is to prevent an occurrence of a contention among plural terminal devices for obtaining a calling telephone number.

Another object of the present invention is to maintain a good usability of a telephone that is connected to a communication control device that supports the caller ID service.

Still another object of the present invention is to enable plural terminal devices or communication control devices to obtain a calling telephone number when plural terminal devices or communication control devices that support the caller ID service are connected to the telephone line.

According to the present invention, a master terminal device that is connected to a telephone line directly is provided with means for setting whether or not to execute the calling telephone number reception sequence in the terminal device. When it is set to execute the calling telephone number reception sequence in the master terminal device, the master terminal device executes the calling telephone number reception sequence, and a connection between the telephone line and the other terminal device is disconnected. When it is set not to execute the calling telephone number reception sequence in the master terminal device, the master terminal device does not execute the calling telephone number reception sequence, and the telephone line is connected with the other terminal device so that the other connected terminal device executes the calling telephone number reception sequence.

### BRIEF DESCRIPTION OF THE DRAWINGS

FIG. 1 is a block diagram of a communication control device according to a first embodiment of the present invention.

FIG. 2 is a diagram showing an example of a connecting operation sequence at a calling with a notice of a calling telephone number.

FIG. 3 is a block diagram of a communication control device according to a second embodiment of the present invention.

FIG. 4 is a block diagram showing an inner structure of the communication control device according to the second embodiment.

FIG. 5 is a flowchart showing an operation when the communication control device of the second embodiment is set to be used.

FIG. 6 is a flowchart showing a normal operation after the communication control device of the second embodiment is set to be used.

FIG. 7 is a flowchart showing another example of the normal operation after the communication control device of the second embodiment is set to be used.

FIG. 8 is a flowchart showing still another example of the normal operation after the communication control device of the second embodiment is set to be used.

FIG. 9 is a block diagram of a communication control device according to a third embodiment of the present invention.

FIG. 10 is a circuit diagram showing an example of a connection switching portion and a hook state detecting portion of the communication control device according to the third embodiment.

FIG. 11 is a diagram showing a switching operation of the communication control device according to the third embodiment.

FIG. 12 is a flowchart showing a basic operation of the communication control device according to the third embodiment.

FIG. 13 is a flowchart showing an operation corresponding to a power-saving mode of a data processing device.

FIG. 14 is a flowchart showing an operation corresponding to an operational state of the data processing device.

FIG. 15 is a block diagram of a communication control device according to a fourth embodiment of the present invention.

FIG. 16 is a block diagram showing an example of a hardware structure of the communication control device according to the fourth embodiment.

FIG. 17 is a flowchart showing an operation of the communication control device according to the fourth embodiment.

FIG. 18 is a flowchart showing another example of the operation of the communication control device according to the fourth embodiment.

FIG. 19 is a block diagram of a communication control device according to a fifth embodiment of the present invention.

FIG. 20 is a block diagram showing an example of a hardware structure of the communication control device according to the fifth embodiment.

FIG. 21 is a flowchart showing an example of an operation of the communication control device according to the fifth embodiment.

FIG. 22 is a block diagram of a communication control device according to a sixth embodiment of the present invention.

FIG. 23 is a block diagram showing a hardware structure of the communication control device according to the sixth embodiment.

FIG. 24 is a flowchart showing an example of an operation of the communication control device according to the sixth embodiment.

FIG. 25 is a diagram showing a recording medium storing a program for executing a method of the present invention.

### DESCRIPTION OF THE PREFERRED EMBODIMENTS

[First Embodiment]

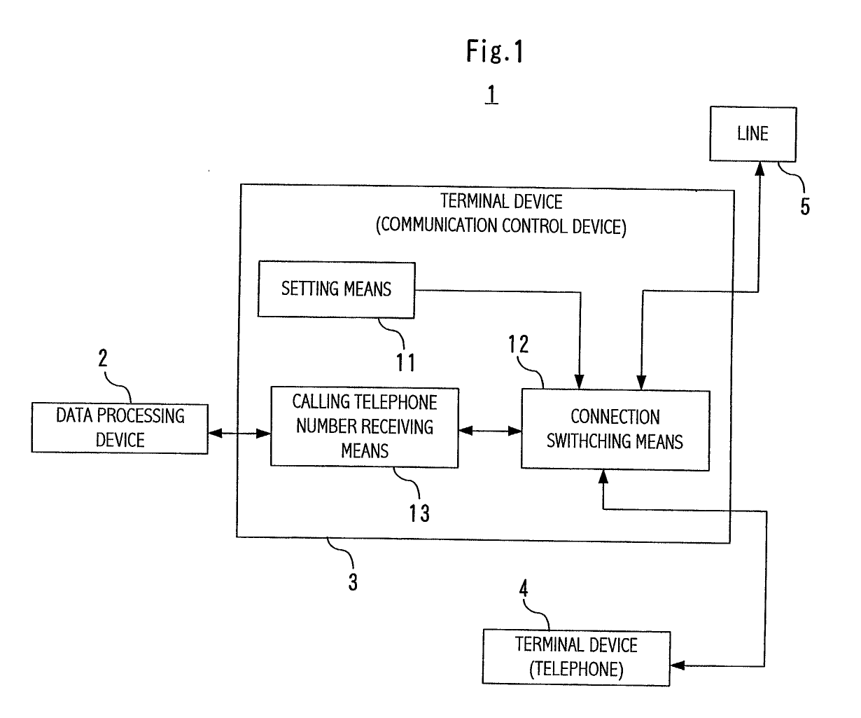

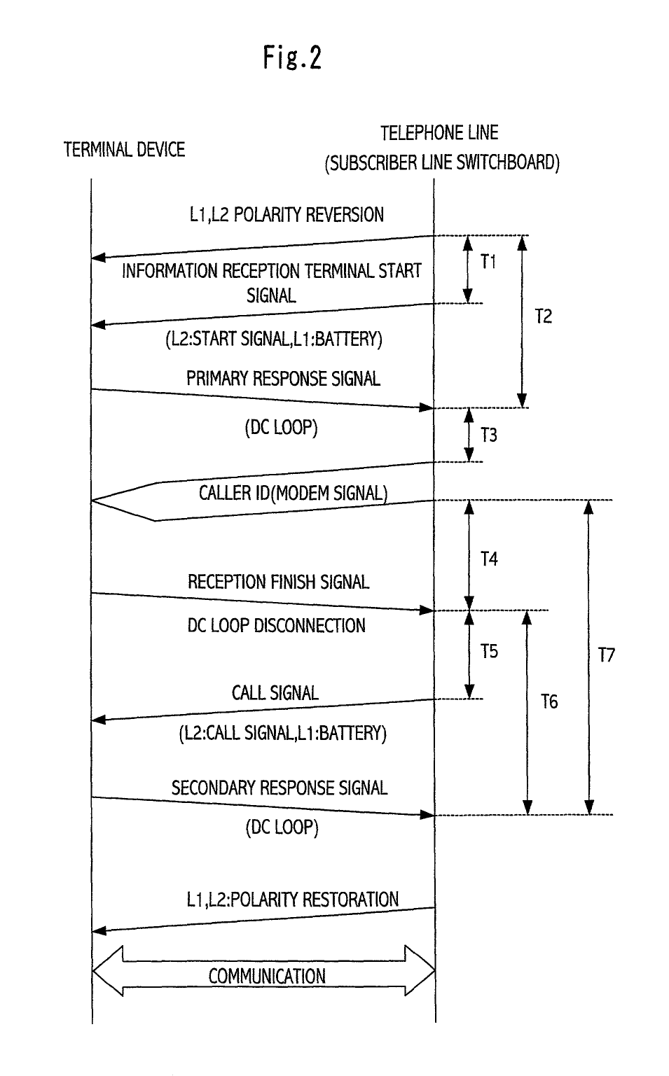

First, a communication control device 3 according to a first embodiment of the present invention will be explained with reference to FIG. 1 and FIG. 2.

In FIG. 1, the communication control device 3 is connected to a data processing device 2 and a telephone 4. The communication control device 3 corresponds to the master terminal device in the present invention, while the telephone 4 corresponds to the other terminal device in the present invention. These devices constitute a sort of computer system 1. In addition, the communication control device 3 is connected to a line 5. The line 5 is a telephone line such as a public telephone line, a private telephone line or a digital line.

The data processing device 2 includes a processing device, a memory, a hard disk drive, another disk drive, a display device, a printer and others. As the disk drive, various kinds of drives for recording media such as a CD-ROM, a MO (a magneto-optical disk) or a floppy disk as necessary. The data processing device 2 includes a call control device. The call control device outputs a control signal for switching communication paths responding to a notice of detecting a ringer signal that is given by the communication control device 3. The data processing device 2 can be a personal computer or a workstation, for example.

The communication control device 3 includes setting means 11, connection switching means 12, calling telephone number receiving means 13 and means for realizing various functions for controlling the communication (not shown).

The setting means 11 is means for setting whether or not to execute the calling telephone number reception sequence at the communication control device 3. The set content of the setting means 11 can be determined by a user's manual operation or a setting signal from the data processing device 2.

The connection switching means 12 connects the line 5 with the communication control device 3 or the telephone 4 in accordance with the set content of the setting means 11. In this case, the communication control device 3 means a functional portion of the communication control device 3 for executing a substantial process. It is the same in the following explanation.

The connection switching means 12 can be switching means for connecting the line 5 selectively with the communication control device 3 or the telephone 4. A relay or a semiconductor switching circuit is used as the switching means.

If the setting means 11 set so that the calling telephone number reception sequence is executed in the communication control device 3, the connection switching means 12 connects the line 5 with the communication control device 3, and the telephone 4 is disconnected from the line 5 at that time. If the setting means 11 set so that the calling telephone number reception sequence is not executed in the communication control device 3, the line 5 is connected with the telephone 4, and the communication control device 3 is disconnected from the line 5 at that time.

However, as in an example that will be explained later, even if the communication control device 3 is disconnected from the line 5, it is possible to connect the communication control device 3 with the line 5 by a method that does not affect the line 5 electrically, e.g., by using a buffer circuit having a sufficiently high input impedance, or by using an optocoupling element.

The calling telephone number receiving means 13 executes the calling telephone number reception sequence in accordance with the set content of the setting means 11. The calling telephone number reception sequence is a predetermined procedure defined for receiving a calling telephone number (a caller ID) from the line 5.

An example of connecting operation sequence in calling with a notice of the calling telephone number will be explained. The following connecting operation sequence is a sequence in a caller ID service that is provided by NTT. In the explanation of FIG. 2, the “telephone line” indicates a switchboard of an office that is connected to the telephone line.

As shown in FIG. 2, a polarity reversing signal is outputted from the telephone line (the line 5) to the terminal device (the communication control device 3) first. After the time T1 (0.1 seconds or more) has passed, a start signal is outputted. The terminal device that received the signal outputs an off-hook signal as a primary response signal to the telephone line. The primary response signal must be outputted in the time T2 (six seconds) after the output of the polarity reversing signal.

After the time T3 (0.1-3.0 seconds) from the primary response signal, a calling telephone number is outputted from the telephone line to the terminal device. The calling telephone number is outputted as a modem signal modulated by a FSK at 1200 bps. The terminal device receives the modem signal and demodulates it so as to obtain the calling telephone number. The terminal device receives the calling telephone number and outputs an on-hook signal as a reception finish signal to the telephone line. The reception finish signal must be outputted in the time T4 (seven seconds) after the output of the modem signal.

The above-mentioned sequence is the calling telephone number reception sequence, and the ensuing sequence is the normal connection sequence. If the terminal device does not have the calling telephone number receiving means 13, or if the terminal device is not connected, the primary response signal is not returned. Therefore, the following normal connection sequence is executed after the time T2 ends.

In the normal connection sequence, after passing the time T5 (0.3 seconds or more) from the output of the reception finish signal, a call signal is outputted from the telephone line to the terminal device. The terminal device that received this signal outputs an off-hook signal as a secondary response signal to the telephone line. The secondary response signal must be outputted after passing the time T6 (0.3 seconds or more) after the output of the reception finish signal and after the time T7 (0.7 seconds or more) from the output of the modem signal.

When the secondary response signal is outputted, a polarity return signal is outputted from the telephone line to the terminal device, and after that, the communication is performed. After finishing the communication, a process for completion is executed.

As explained above, in Japan (NTT), a false call signal is used as the start signal of the calling telephone number reception sequence. The call signal is used as the start signal in the U.S.A., and the polarity reversing signal is used as the start signal in the U.K. and in Sweden.

In addition, as a signal for transmitting the calling telephone number, the modem signal is used in Japan, in the U.S.A. and in the U.K., while a DTMF signal is used in Sweden.

Referring to FIG. 1, the calling telephone number receiving means 13 of the communication control device 3 executes the above-mentioned calling telephone number reception sequence so as to obtain the calling telephone number. However, even if the calling telephone number reception sequence is not executed, the calling telephone number can be obtained by demodulating the modem signal if it is inputted.

The communication control device 3 executes the calling telephone number reception sequence by the calling telephone number receiving means 13 and executes other various processes such as the normal connection sequence with line 5. The communication control device 3 comprises a CPU, a ROM that stores programs and data, a RAM, various interface circuits, a timer circuit, a signal generator circuit, an analog-to-digital converter circuit, a digital-to-analog converter circuit, a modulation and demodulation circuit, a power source circuit, and other hardware circuits.

The communication control device 3 can be realized as an independent device housed in a case, or an independent unit of printed circuit board, or a common unit of printed circuit board including other circuits, or a card that can be inserted in a slot of a computer, or in other various forms.

Next, the operation of the above-mentioned computer system 1 will be explained.

First, in the communication control device 3, the case will be explained in which the setting means 11 sets the calling telephone number reception sequence to be executed at the communication control device 3.

In this case, the connection switching means 12 connect the line 5 with the communication control device 3, and the telephone 4 is disconnected from the line 5. When a call occurs from the line 5, the calling telephone number reception sequence is executed between the line 5 and the communication control device 3. During the execution, the telephone 4 is not involved in the calling telephone number reception sequence. Therefore, the calling telephone number reception sequence is executed normally only by the communication control device 3 without a contention with the telephone 4. The communication control device 3 can obtain the calling telephone number correctly.

After the calling telephone number reception sequence finished, the normal connection sequence is executed at the communication control device 3 or at the telephone 4 by switching operation of the connection switching means 12. In the case being switched to the telephone 4, if the telephone 4 supports the caller ID service, the calling telephone number obtained by the communication control device 3 can be transmitted to the telephone 4 as being explained below. In this way, the calling telephone number can be obtained both at the communication control device 3 and at the telephone 4.

Next, in the communication control device 3, the case will be explained in which the setting means 11 sets the calling telephone number reception sequence not to be executed at the communication control device 3.

In this case, the connection switching means 12 connects the line 5 with the telephone 4, and the communication control device 3 is disconnected from the line 5. When a call occurs from the line 5, the calling telephone number reception sequence is executed between the line 5 and the telephone 4. During the execution, the communication control device 3 is not involved in the calling telephone number reception sequence. Therefore, the calling telephone number reception sequence is executed normally only by the telephone 4 without a contention with the communication control device 3. The telephone 4 can obtain the calling telephone number correctly. After the calling telephone number reception sequence finished, the normal connection sequence is executed at the telephone 4.

In this case, if a buffer circuit having a high input impedance for the connection switching means 12, so that the modem signal on the line 5 is detected, the calling telephone number can be obtained at the communication control device 3, too. Thus, both the telephone 4 and the communication control device 3 can obtain the calling telephone number.

[Second Embodiment]

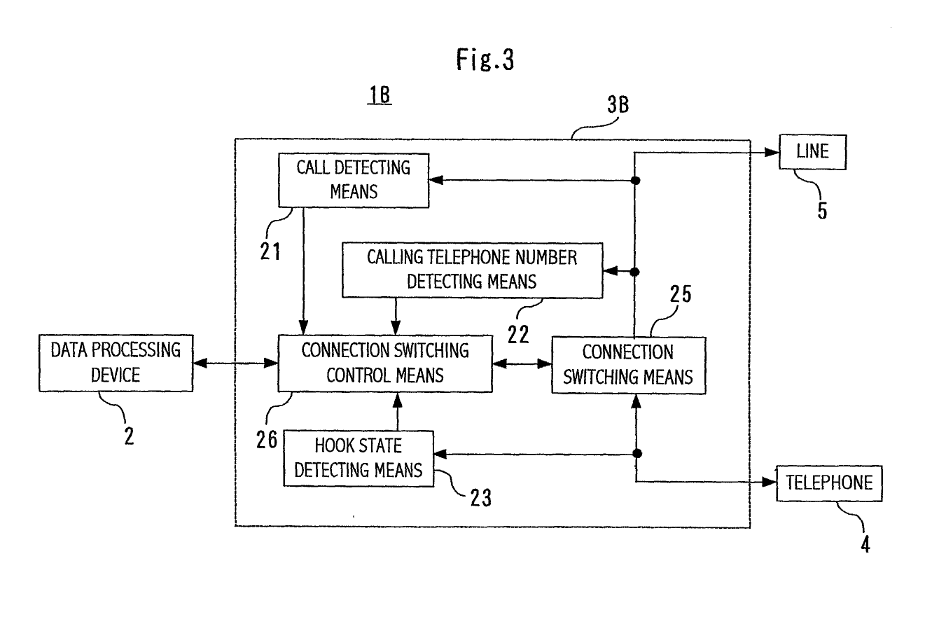

Next, a communication control device 3B according to a second embodiment of the present invention will be explained with reference to FIGS. 3-8.

The communication control device 3B of the second embodiment connects or disconnects the telephone 4 with the line 5 by the command from the data processing device 2 and the state of the communication, so that the contention between the communication control device 2 and the telephone 4 is avoided for obtaining the calling telephone number. In addition, a generation of a call sound due to the calling telephone number notifying signal can be prevented.

In FIG. 3, the communication control device 3B includes call detecting means 21, calling telephone number detecting means 22, hook state detecting means 23, connection switching means 25 and connection switching control means 26.

A basic operation of the communication control device 3B is as follows.

The call detecting means 21 detect a call from the line 5. The calling telephone number detecting means 22 detect a calling telephone number. The hook state detecting means 23 detect an on-hook or an off-hook state of the telephone 4. These detections are notified to the connection switching control means 26. The connection switching means 25 make or break the line that connects the line 5 with the telephone 4. The connection switching control means 26 control the connection switching means 25 in accordance with a command from the data processing device 2 and information from the call detecting means 21, the calling telephone number detecting means 22 and the hook state detecting means 23.

The operation of the communication control device 3B that obtains the calling telephone number is as follows.

When the connection switching control means 26 receives a calling telephone number reception command that is a command for letting the communication control device 3B execute the process of obtaining the calling telephone number during the operational state of the data processing device 2, the connection switching means 25 disconnect the line 5 and the telephone 4. In this state, if the calling telephone number detecting means 22 detects the calling telephone number, the connection switching control means 26 inform the data processing device 2 of the calling telephone number, and the connection switching means 25 connect the line 5 and the telephone 4.

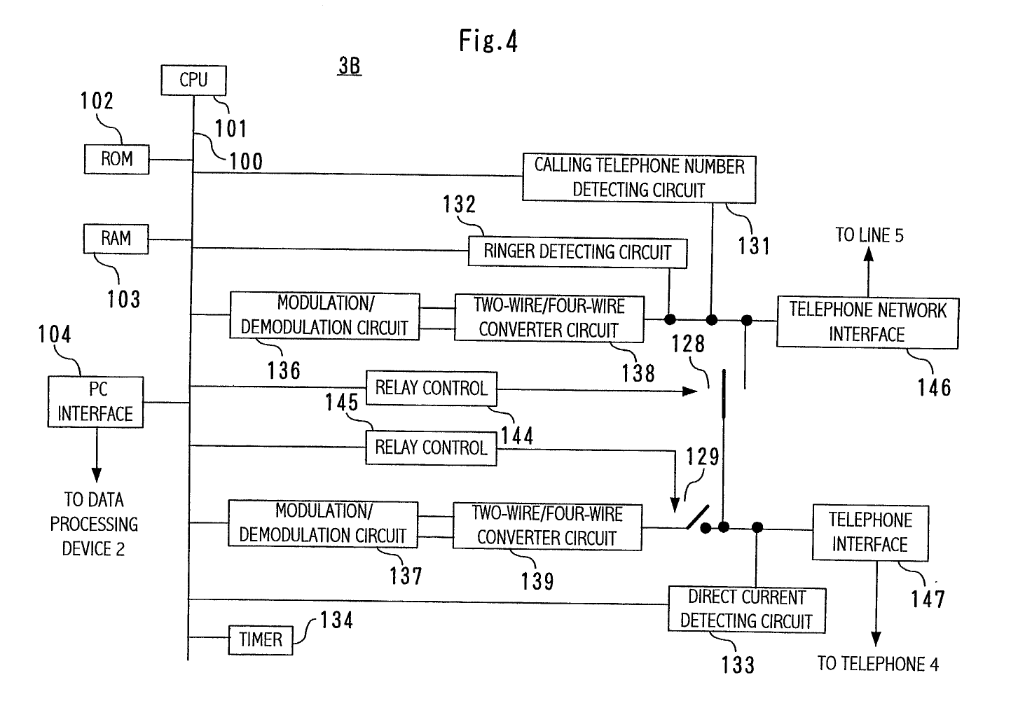

In FIG. 4, a telephone network interface 146 is an interface for connecting the communication control device 3B with the line 5 such as a public line, while a telephone interface 147 is an interface for connecting the communication control device 3B with a telephone 4. A CPU 101 is a CPU for controlling the operation of the communication control device 3B. A ROM 102 and a RAM 103 are memories for storing and executing information such as a program that is necessary for controlling the communication control device 3B. A bus 100 is a bus that is used for transmitting information in the communication control device 3B. A PC interface 104 is an interface for being connected to the data processing device 2 for giving a command to the communication control device 3B. A relay 128 is controlled by the CPU 101 via a relay control 144. When the relay 128 is off (not active), the telephone 4 that is connected to the telephone interface 147 is connected to the line 5 directly.

Modulation/demodulation circuits 136, 137 and two-wire/four-wire converter circuits 138, 139 are circuits for letting the communication control device 3B work as a modem and does not have a direct relationship with the present invention. In addition, a relay 129 is controlled by the CPU 101 via a relay control 145. This relay 129 also does not have a direct relationship with the present invention since it is a circuit for letting the communication control device 3B as a modem.

A direct current detecting circuit 133 monitors a current that flows in the telephone interface 147. When the current is turned on, it is decided that the telephone becomes the off-hook state. When the current becomes turned off, it is decided that the telephone becomes the on-hook state. These decisions are notified to the CPU 101 via a specific signal line of the bus 100. A ringer detecting circuit 132 monitors the telephone network interface 146, executes the ringer detection, and inform the CPU 101 via a specific signal line of the bus 100. In addition, a calling telephone number detecting circuit 131 monitors the telephone network interface 146, detects a calling telephone number notifying signal, obtains a calling telephone number, and informs the CPU 101 via a specific signal line of the bus 100.

The timer 134 is set or reset when the CPU 101 receives a ringer notice from the ringer detecting circuit 132, and it is notified to the CPU 101 after a predetermined time has passed.

Hereinafter, the operation in the second embodiment will be explained with reference to a flowchart.

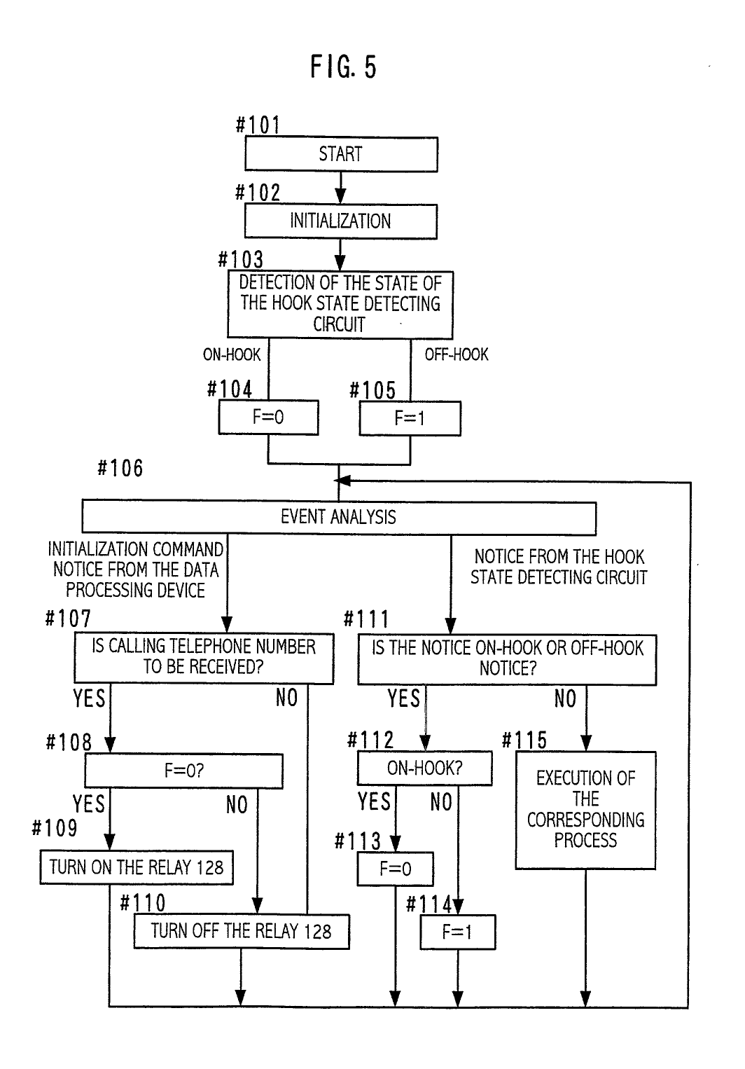

FIG. 5 shows an operation of the communication control device 3B when it is set for use. The content of FIG. 5 correspond to claims 2, 6, 7 and 8.

The process of the flowchart that is shown in FIG. 5 is executed when the setting of the communication control device 3B is determined, e.g., at the start of the communication control device 3B. When the process starts (#101), an initialization of registers and variables is executed as an initialization of the inside of the communication control device 3B (#102). In addition, the state of the hook state detecting circuit is detected (#103). If it is the on-hook state, the variable F is set to zero (#104). If it is the off-hook, the variable F is set to one (#105). Then it becomes an event waiting state (#106).

In this state, if a notice is received from the hook state detecting circuit for example, the CPU 101 decides whether or not the notice is the on-hook or off-hook notice (#111). If it is the on-hook or off-hook notice, the CPU 101 decides whether or not the notice indicates the on-hook (#112). If it is the on-hook, the variable F is set to zero (#113). If it is off-hook, the variable F is set to one (#114).

In addition, if it is decided to be a notice except the on-hook or off-hook notice in Step #111, the CPU 101 executes a process responding to the notice (#115). After finishing these processes, it returns to the event waiting state (#106).

In the state of Step #106, if a command notice is received from the data processing device 2 for example, the CPU 101 decides whether the command is a calling telephone number reception command or a calling telephone number non-reception command (#107). If it is the calling telephone number reception command, the CPU 101 decides whether the content of the variable F indicating the hook state is zero or not (#108). If the content of the variable F is zero, the CPU 101 controls the relay control 144 and turns on the relay 128 (#109). If the content of the variable F is not zero, the CPU 101 controls the relay control 144 and turn off the relay 128 (#110). Furthermore, in Step #107, if the command is the calling telephone number non-reception command, the CPU 101 controls the relay control 144 and turn off the relay 128 (#110). After finishing the setting of these relays 128, the CPU 101 finishes the process of the flowchart and returns to the normal process.

In the present embodiment, the calling telephone number reception command or the calling telephone number non-reception command is notified from the data processing device 2. However, it can be a decision of the CPU 101 inside the communication control device 3B. In addition, the sequence of the hook state detection from Step #111 to Step #115 can be operated continuously after setting for use.

Next, the normal operation of the communication control device 3B after setting for use will be explained.

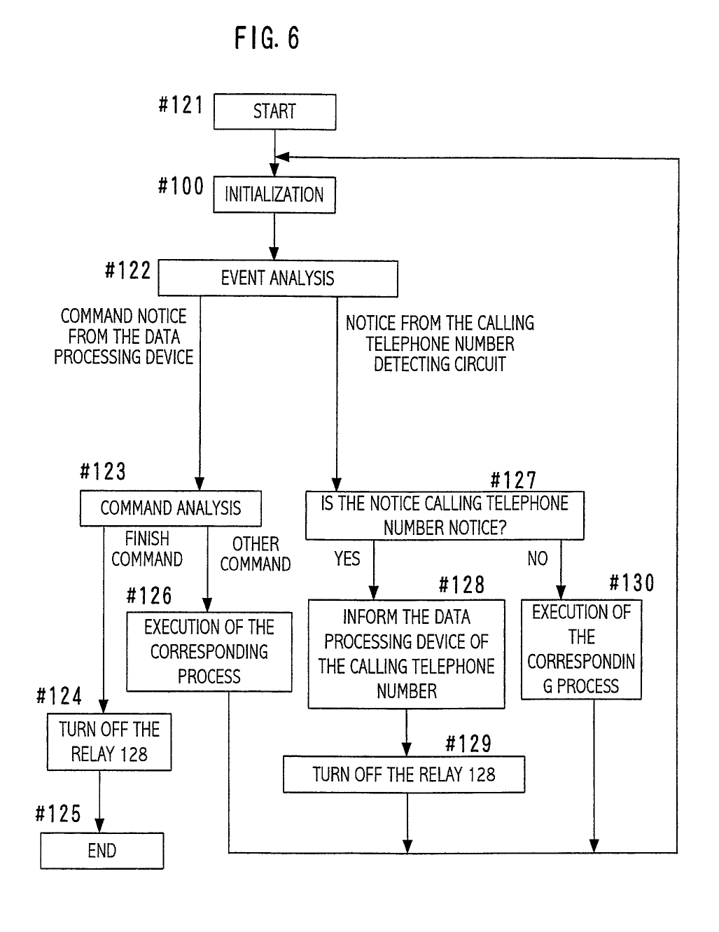

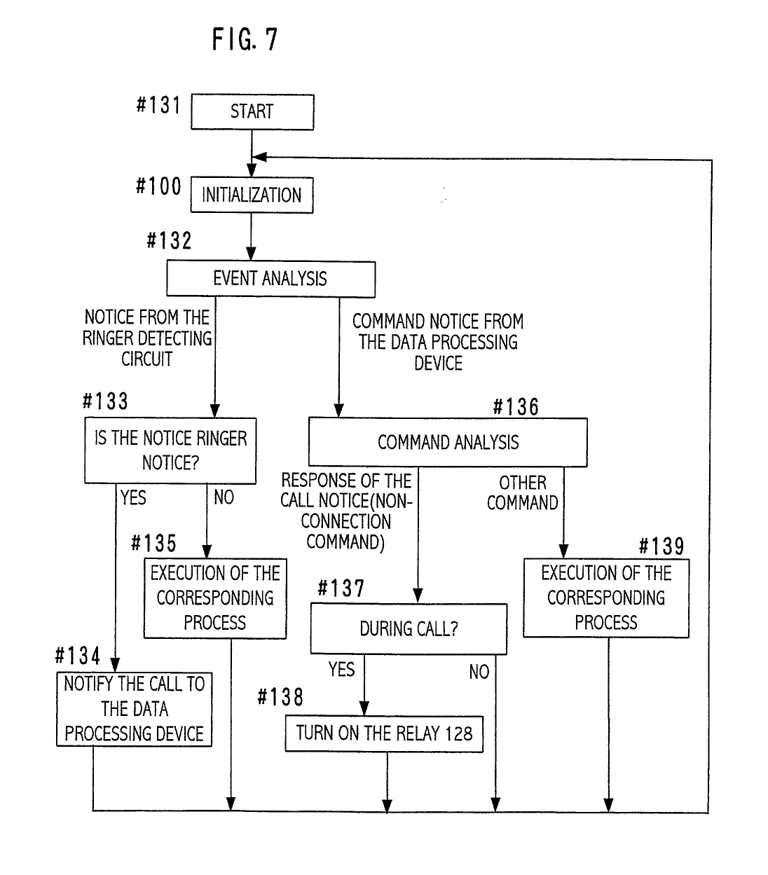

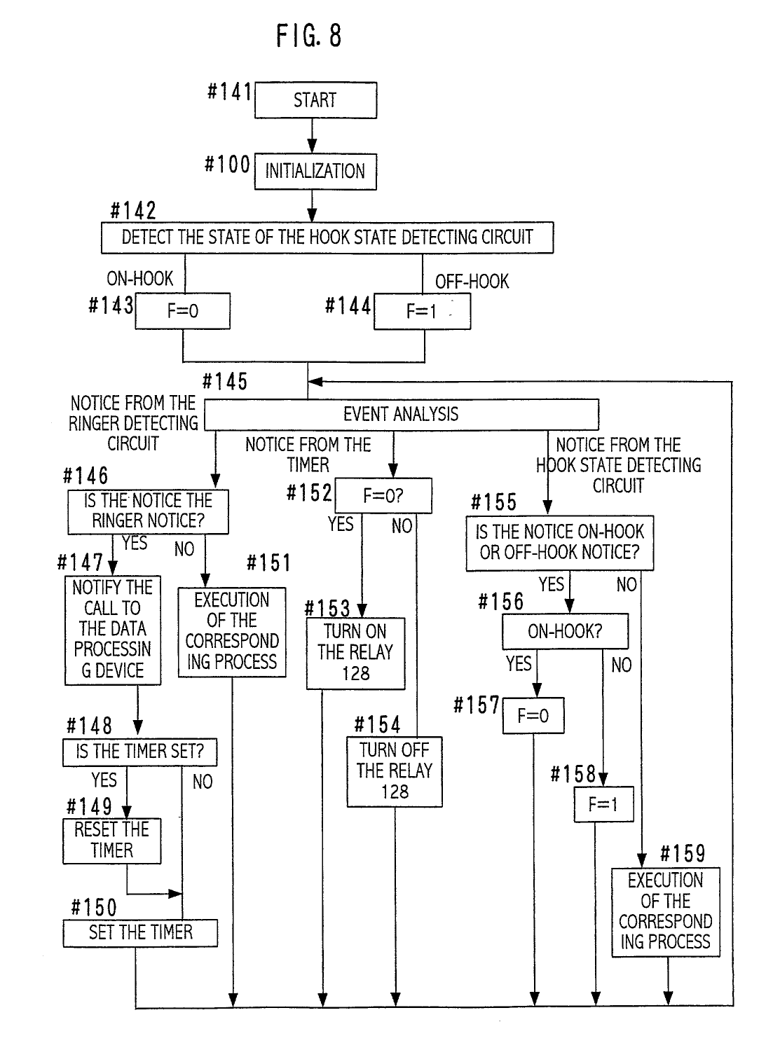

FIGS. 6-8 show various examples of the normal operation of the communication control device 3B after setting for use. The content of FIG. 6 correspond to claims 9 and 10. The content of FIG. 7 correspond to claim 11. The content of FIG. 8 correspond to claims 12 and 13.

Concerning the process of the flowchart shown in FIG. 6, when the process starts (#121), the initialization process is executed as shown in the flowchart of FIG. 5(#100). Then, it becomes the event waiting state (#122).

In this state, if a command notice is received from the data processing device 2 for example, the CPU 101 analyzes the notified command (#123). If the command is a finish command, the CPU 101 controls the relay control 144 and turn off the relay 128 (#124). Then, the CPU 101 executes other process that is necessary for finishing and finishes the execution (#125). Furthermore, in Step #123, if the command is a command except the finish command, the process for the command is executed (#126). When the process is finished, it returns to the event waiting state (#122).

In the state of Step #122, if a notice is received from the calling telephone number detecting circuit 131 for example, the CPU 101 decides whether or not the notice is the calling telephone number notice (#127). If the notice is the calling telephone number notice, the CPU 101 notifies the calling telephone number to the data processing device 2 (#128) and controls the relay control 144 so as to turn off the relay 128 (#129). As a result, the line 5 is connected with the telephone 4, and the following ringer signal is transmitted to the telephone 4. In addition, if it is decided to be a notice except the calling telephone number notice in the Step #127, the CPU 101 executes the process for the notice (#130). After finishing these processes, it returns to the event waiting state (#122).

Concerning the process of the flowchart that is shown in FIG. 7, when the process starts (#131), the initialization process that is shown in the flowchart of FIG. 5 is executed (#100). Then it returns to the event waiting state (#132).

In this state, if the notice is received from the ringer detecting circuit for example, the CPU 101 decides whether or not the notice is the ringer notice (#133). If the notice is the ringer notice, the CPU 101 notifies the call to the data processing device 2 (#134). If the CPU 101 decides it is a notice except the ringer notice, the CPU 101 executes the process for the notice (#135). After finishing these processes, it returns to the event waiting state (#132).

In the state of Step #132, if the command notice is received from the data processing device 2 for example, the CPU 101 decides whether or not the command is the non-connection command for the call notice (#136). If the command is the non-connection command, the CPU 101 decides whether it is still calling or not (#137). If it is still calling, the CPU 101 controls the relay control 144 so as to turn on the relay 128 (#138). If it is not calling, the present state is maintained. Furthermore, in Step #136, if it is decided to be a command except the non-connection command, the CPU 101 executes the process for the command (#139). After these processes are finished, it returns to the event waiting state (#132).

Concerning the process of the flowchart that is shown in FIG. 8, when the process starts (#141), the initialization process that is shown in the flowchart of FIG. 5 is executed (#100). In addition, the state of the hook state detecting circuit is detected (#142). If it is the on-hook state, the variable F is set to zero (#143). If it is the off-hook state, the variable F is set to one (#144), so as to become the event waiting state (#145).

In this state, if a notice is received from the ringer detecting circuit for example, the CPU 101 decides whether the notice is the ringer notice or not (#146). If the notice is the ringer notice, the CPU 101 notifies the call to the data processing device 2 (#147), and decides whether the timer 134 is already set or not (#148). If it is decided that the timer 134 is already set, the CPU 101 resets the timer 134 (#149) and sets the timer 134 again (#150). Furthermore, in Step #148, if it is decided that the timer 134 is not set, the timer 134 is set (#150). In addition, if it is decided to be a notice except the ringer notice in Step #146, the CPU 101 executes the process for the command (#151). After these processes are finished, it returns to the event waiting state (#145).

In the state of Step #145, if a notice is received from the timer 134 for example, the CPU 101 decides whether the content of the variable F indicating the hook state is zero or not (#152). If the content of the variable F is zero, the CPU 101 controls the relay control 144 and turn on the relay 128 (#153). As a result, the line 5 is connected with the telephone 4 so that the communication becomes possible. If the content of the variable F is not zero, the CPU 101 controls the relay control 144 and turns off the relay 128 (#154). After these processes are finished, it returns to the event waiting state (#145).

In the state of Step #145, if a notice is received from the hook state detecting circuit for example, the CPU 101 decides whether the notice is the on-hook or off-hook notice or not (#155). If the notice is the on-hook or off-hook notice, the CPU 101 decides whether the notice indicates on-hook or not (#156). If the notice is on-hook, the variable F is set to zero (#157). If the notice is off-hook, the variable F is set to one (#158). Furthermore, in Step #155, if it is decided to be a notice except the on-hook or off-hook notice, the CPU 101 executes the process for the notice (#159). After these processes are finished, it returns to the event waiting state (#145).

The above-mentioned operations of FIGS. 5, 6, 7 and 8 are performed by the program memorized in the ROM 102 using the RAM 103 under control of the CPU 101. The recording medium that memorizes the program constitutes a part of the present invention.

According to the above-mentioned embodiment, the command from the data processing device 2 and the notice from the each detecting circuit that notifies the communication state let the CPU 101 inside the communication control device 3B control the connection and the disconnection between the telephone 4 and the line 5, so as to prevent a generation of a contention between the communication control device 3B and the telephone 4 for obtaining the calling telephone number. In addition, a generation of a call sound due to the calling telephone number notifying signal.

The present invention is not limited to the above-mentioned example.

The communication control device 3B of the above-mentioned embodiment and the operation thereof can prevent the contention between the communication control device and the telephone for obtaining the calling telephone number that can be generated when using a communication control device such as a modem that can support the caller ID service and a call sound generated by a calling telephone number notifying signal in a telephone that does not support the caller ID service.

Furthermore, in the operation of FIG. 7, the data processing device decides whether or not to notify the call to the telephone. In accordance with the decision, the call is notified or is not notified to the telephone.

Furthermore, in the operation of FIG. 8, if the call is received, and when the caller side disconnects before the reception side responds, it is decided by the fact that the ringer notice is not detected for a predetermined period, so that the connection of the line with the telephone can return to the waiting state.

[Third Embodiment]

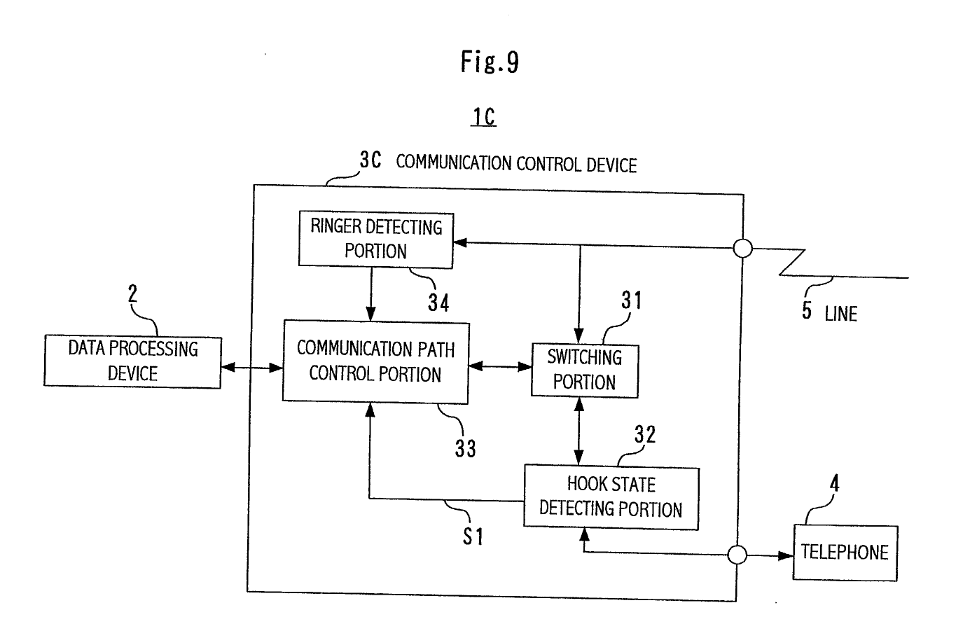

Next, a communication control device 3C according to a third embodiment of the present invention will be explained with reference to FIGS. 9-14.

In FIG. 9, the communication control device 3C includes a switching portion 31, a hook state detecting portion 32, a communication path control portion 33 and a ringer detecting portion 34.

The switching portion 31 connects and disconnects the communication path between the telephone 4 and the line 5. Namely, in the switching portion 31, the telephone 4 is connected with the line 5 normally, and the telephone 4 is separated when various events are generated.

The hook state detecting portion 32 detects the off-hook and the on-hook of the telephone 4. The on-hook is a state where a handset of the telephone 4 is on the hook, while the off-hook is a state where the handset is off the hook.

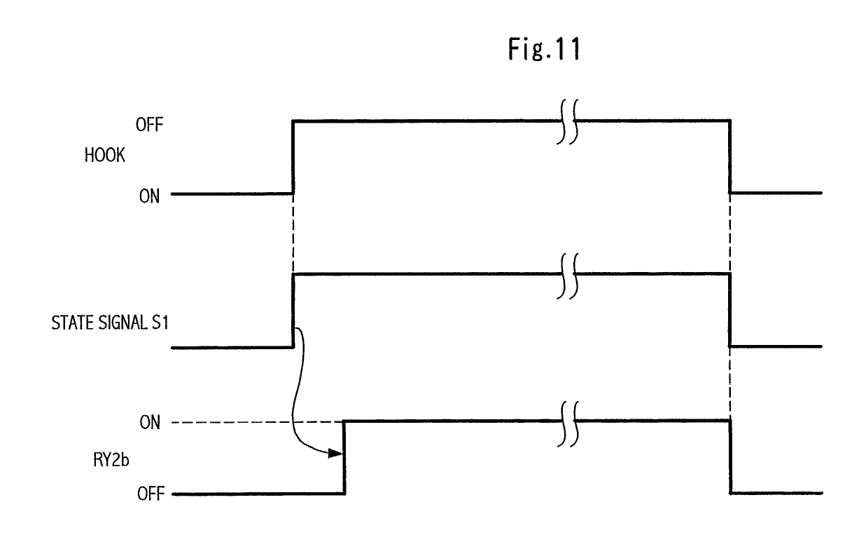

The communication path control portion 33 controls the switching portion 31 as explained above. Namely, as shown in FIG. 11 too, the communication path control portion 33 enables the connection of the communication path between the telephone 4 and the line 5 responding to turning on of the state signal S1 when detecting the off-hook of the telephone 4. In addition, when the on-hook of the telephone 4 is detected, the state signal S1 turns off. Responding to this, the communication path between the telephone 4 and the line 5 is broken.

In addition, when the data processing device 2 becomes a power-saving mode (also referred to as a suspend mode or a sleep mode), the communication path control portion 33 detects it and controls to enable the connection of the communication path between the line 5 and the telephone 4. When the notice that the data processing device 2 releases the power-saving mode is received, the connection between the line 5 and the telephone 4 is broken under the condition that the telephone 4 is on-hook.

In addition, the communication path control portion 33 regularly issues a notice to the data processing device 2 for inquiring the operation state of the data processing device 2. When the notice is issued, the presence or absence of the response and the content thereof are monitored for a predetermined period of time. If there is an abnormal state such that the data processing device 2 cannot receive the call, or if there is no response during a predetermined period of time, the communication path is controlled to connect the line 5 with the telephone 4.

Furthermore, when the off-hook of the telephone 4 is detected at the power supply start or the reset of the communication control device 3C, the communication path between the telephone 4 and the line 5 is made.

The ringer detecting portion 34 detects the ringer signal when there is a call from the line 5, and the detection is outputted to the data processing device 2 via the communication path control portion 33.

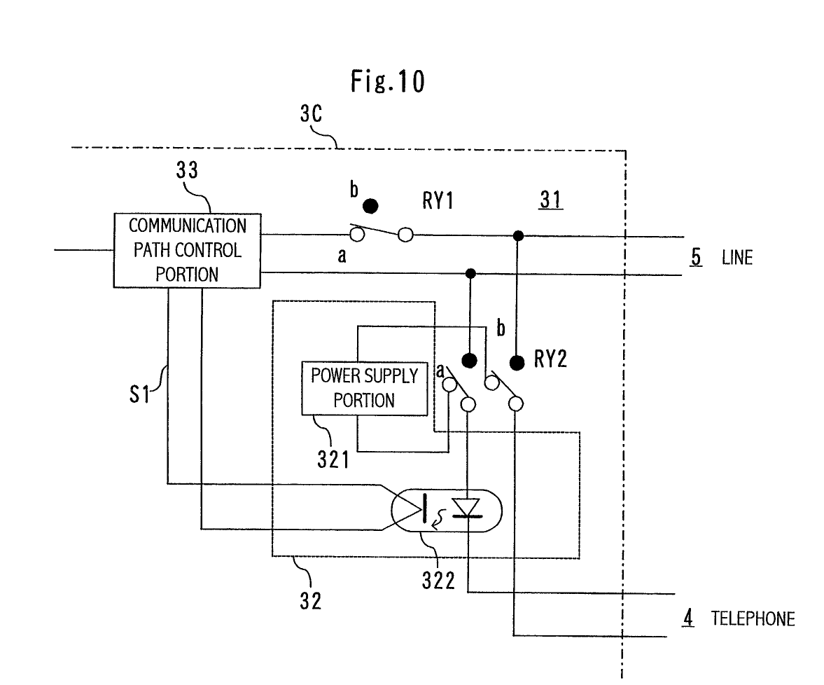

As shown in FIG. 10 well, the switching portion 31 includes a relay RY1 that is disposed between the line 5 and the communication path control portion 33, and a relay RY2 that is disposed between the line 5 and the telephone 4. In the figure, the normal close contact of the relay is shown by a dot. The ringer detecting portion 34 is connected to the primary side of the line 5 though it is not shown in FIG. 10.

The hook state detecting portion 32 includes a power supply portion 321 and a photo-coupler 322. The power supply portion 321 emulates to supply a DC voltage by the line 5.

When the telephone 4 is disconnected from the line 5, the telephone 4 is supplied with the same DC voltage as the line 5. The photo-coupler 322 detects current that flows in the communication path to the telephone 4. When the current flows, the state signal SI that is the output of the photo-coupler 322 becomes the ON level. Namely, when the telephone 4 becomes off-hook, direct current flows into the telephone 4, and the output of the photo-coupler 322, i.e., the state signal S1 becomes the ON level. On the contrary, when the telephone 4 becomes on-hook, the output of the photo-coupler 322, i.e., the state signal S1 becomes the OFF level since no direct current flows.

The relay RY2 is activated to be turned on by the control of the communication path control portion 33. In this case, as shown in FIG. 10 as the initial state, the a-contact RY2a of the relay RY2 becomes turned on so that the telephone 4 is connected to the power supply portion 321, and the b-contact RY2b of the relay RY2 becomes turned off so that the telephone 4 is disconnected from the line 5. In this case, during the state of waiting for a call, the relay RY1 is turned off so that the a-contact RY1a thereof becomes turned off, and the line 5 is disconnected from the communication path control portion 33.

Therefore, in this normal operational state, when a call is received from the line 5, the ringer detecting portion 34 detects the ringer signal. The detection is transmitted to the data processing device 2 via the communication path control portion 33. The data processing device 2 executes an appropriate process in accordance with the application, or gives an appropriate instruction for response to the communication control device 3C. The communication control device 3C, responding to the instruction, turns on the relay RY1 for example so as to connect the communication path control portion 33 with the line 5.

In the normal operational state, the telephone 4 is disconnected from the line 5. Therefore, when lifting the handset from the telephone 4 for calling, the telephone 4 becomes off-hook, which is detected by the photo-coupler 322. Then, the communication path control portion 33 switches the relay RY2 to the OFF state using the output of the photo-coupler 322. Thus, the b-contact RY2b of the relay RY2 becomes turned on, so that the line 5 is connected to the telephone 4. At the same time, the power supply portion 321 is disconnected from the telephone 4. However, the photo-coupler 322 normally detects the hook state of the telephone 4.

When putting the handset back to the telephone 4, the telephone 4 becomes on-hook which is detected by the photo-coupler 322. Then, the communication path control portion 33 turns on the relay RY2 using the output of the photo-coupler 322. Thus, the telephone 4 is reconnected to the power supply portion 321.

In this way, though the telephone 4 is normally disconnected from the line 5, the telephone 4 is automatically connected with the line 5 for calling as usual.

In addition, during the telephone 4 is used, when the telephone 4 becomes off-hook and the telephone 4 is connected with the line 5, the communication control device 3C can stop its operation due to a power failure or a cutting of the power source. At that time, there is no problem since the contact of the relay RY2 connects the telephone 4 with the line 5. However, the operation may have a trouble when the communication control device 3C is supplied with power again and is reset. In this case, however, when the communication control device 3C is supplied with the power or is reset, the off-hook state of the telephone 4 is detected, so that the telephone 4 is connected with the line 5 via the communication path. Therefore, there is no problem.

Furthermore, when the data processing device 2 enters the power-saving mode, the communication path control portion 33 detects it, so that the relay RY1 and RY2 are turned off. Thus, the line 5 is connected with the telephone 4. Accordingly, when the data processing device 2 enters the power-saving mode, a call from the line 5 can be received by the telephone 4.

When the data processing device 2 releases the power-saving mode, the notice is transmitted from the data processing device 2 to the communication control device 3C. The communication control device 3C, when receiving the notice, turn on the relay RY2 so as to return to the normal operational state under the condition that the telephone 4 is on-hook.

In this way, according to the communication control device 3C of the present embodiment, the telephone 4 that is connected to the communication control device 3C can be maintained in a good usability.

Next, the operation of the communication control device 3C will be explained with reference to a flowchart.

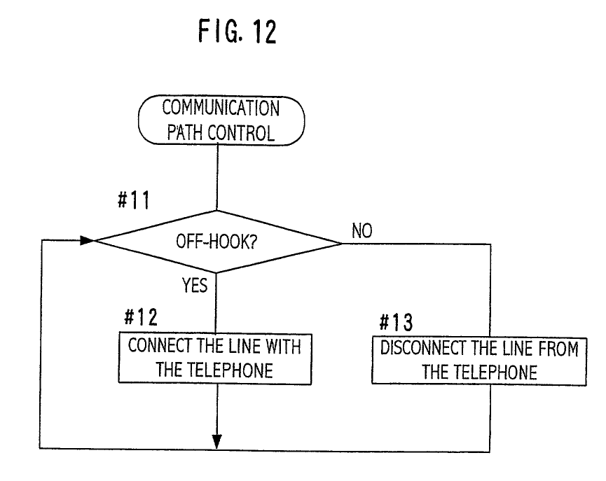

As shown in FIG. 12, in the normal operational state where the data processing device 2 is connected with the line 5, when the off-hook state of the telephone 4 is detected (Yes in #11), the telephone 4 is connected with the line 5 via the communication path (#12). If the on-hook state of the telephone 4 is detected (No in #11), the telephone 4 is disconnected from the line 5 (#13).

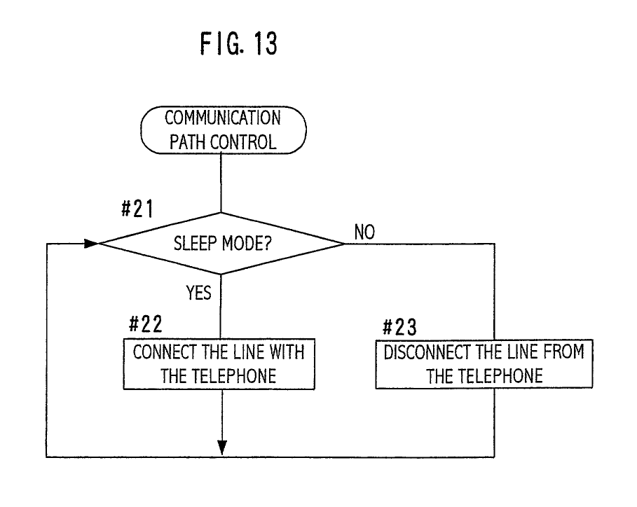

As shown in FIG. 13, in the normal operational state where the data processing device 2 is connected with the line 5, an event is waited. If the power-saving mode (the sleep mode) is set (Yes in #21), the telephone 4 is connected with the line 5 via the communication path (#22). When the power-saving mode is released (No in #21), the telephone 4 is disconnected from the line 5 (#23).

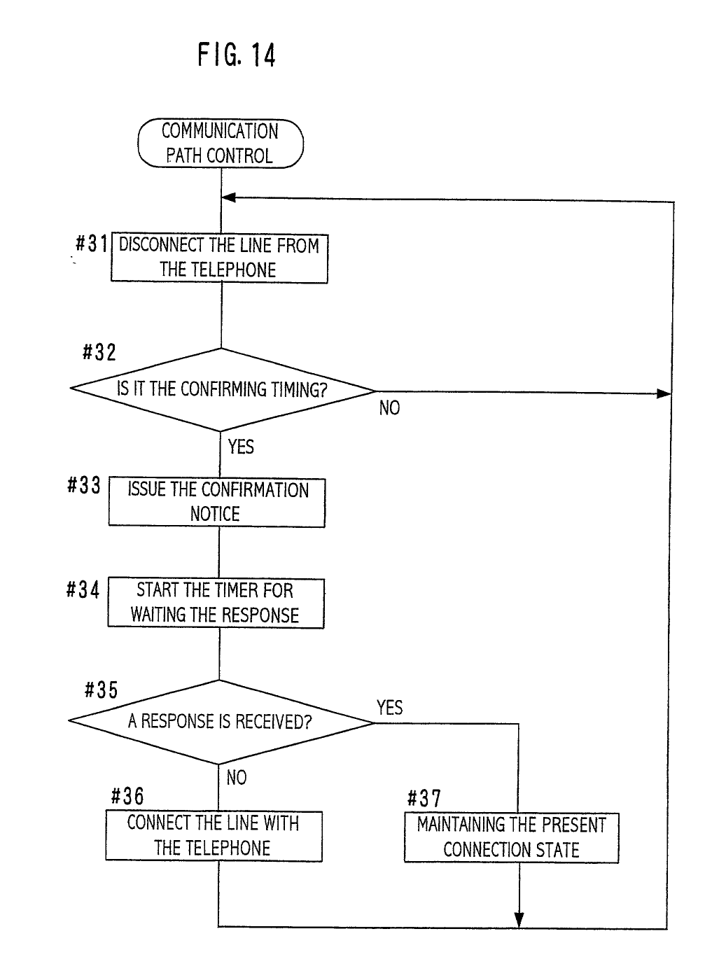

As shown in FIG. 14, in the normal operational state where the line 5 is disconnected from the telephone 4 (#31), timing for confirming the operation state of the data processing device 2 is waited (#32). When the confirming timing comes (Yes in #32), the confirmation notice is issued to the data processing device 2 (#33). The timer for waiting the response is started (#34). If a normal response is received from the data processing device 2 in the passing time of the timer (Yes in #35), the connection state of the communication control device 3C is maintained (#37). If there is no response from the data processing device 2 in the passing time of the timer (No in #35), the telephone 4 is connected with the line 5 via the communication path (#36).

In this embodiment, the power supply portion 321 and the photo-coupler 322 are used for the hook state detecting portion 32. However, various sensors or detecting circuits can be used instead of them. The variation of the hook state of the telephone 4 can be generated not only by lifting and returning the handset but also by pushing an off-hook button. The relays RY1 and RY2 that are used for the switching portion 31 can be various contact structure types. The time from turning on the state signal S1 until switching of the relays RY1 and RY2 can be set to any value from zero to an appropriate time. In addition, a semiconductor switching circuit can be used instead of the relays RY1 and RY2. The structure of the communication path control portion 33 can be various types. In addition, the structure, the process content, the process order or the process timing of the communication control device 3C or the data processing device 2 can be modified appropriately in accordance with the object of the present invention.

[Fourth Embodiment]

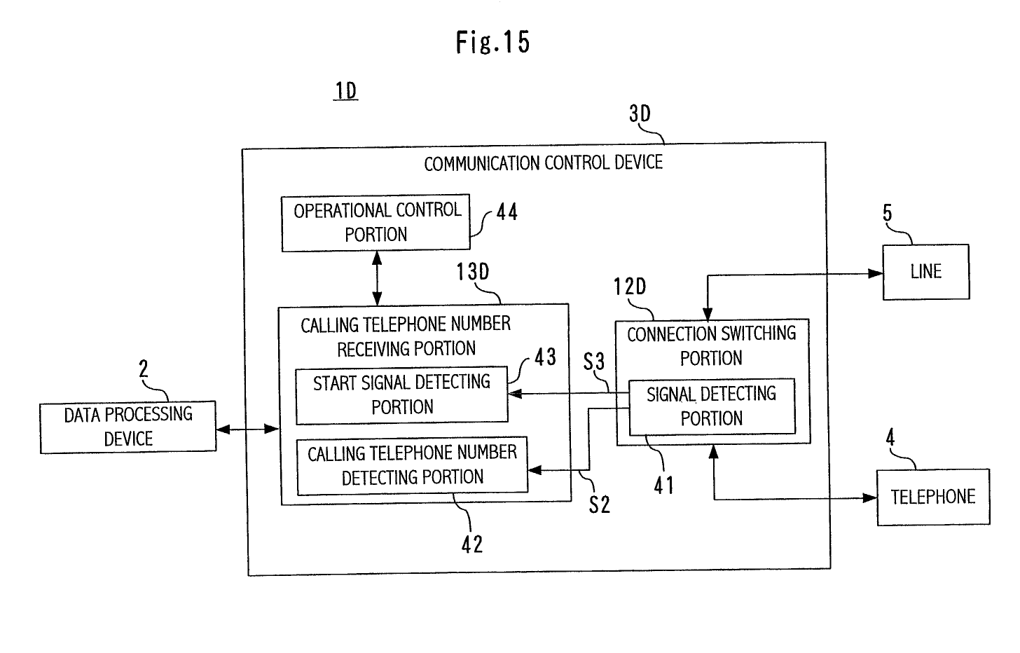

Next, a communication control device 3D according to a fourth embodiment of the present invention will be explained with reference to FIGS. 15-18.

In FIG. 15, a basic structure and function of the communication control device 3D are the same as the communication control device 3 that was explained with reference to FIG. 1. Here, the structure and function that are unique to the fourth embodiment will be explained.

The communication control device 3D includes a connection switching portion 12D, a calling telephone number receiving portion 13D, and an operational control portion 44. The connection switching portion 12D has a signal detecting portion 41, and the calling telephone number receiving portion 13D has a calling telephone number detecting portion 42 and a start signal detecting portion 43.

The signal detecting portion 41 detects signals that are transferred between the telephone 4 and the line 5 so as to output the detected signals S2 and S3. The detected signal S2 is a modem signal including the calling telephone number, while the detected signal S3 is a signal including the start signal. The signal detecting portion 41 can be, for example, a buffer circuit having a high input impedance or a photo-coupler that works by the current flowing in the communication path.

The calling telephone number detecting portion 42 is a part of the function of the calling telephone number receiving portion 13D. The calling telephone number detecting portion 42 demodulates the detected signal S2 that is outputted by the signal detecting portion 41, so as to obtain the calling telephone number. The calling telephone number detecting portion 42 corresponds monitoring means of the present invention.

There are two operations of the calling telephone number detecting portion 42. One is the operation A of normally monitoring the detected signal S2 that is outputted by the signal detecting portion 41, and the other is the operation B of starting the operation when the start signal in the calling telephone number reception sequence is detected while the operation is normally stopped.

The calling telephone number detecting portion 42 is normally realized both by a software (program) and a hardware. The above-mentioned operation A is the case where the software is normally executed, for example. The operation B is the case where the software is not normally executed when an operational flag is zero, and the flag is set when the start signal is detected. In the case of the operation B, the load of the CPU is reduced, so that the process speed can be increased.

The start signal detecting portion 43 is a part of the function of the calling telephone number receiving portion 13D. The start signal detecting portion 43 detects the start signal of the calling telephone number reception sequence that is executed between the telephone 4 and the line 5 in accordance with the detected signal S3.

The operational control portion 44 starts the operation of the calling telephone number detecting portion 42 when the start signal is detected in accordance with the detected signal S3.

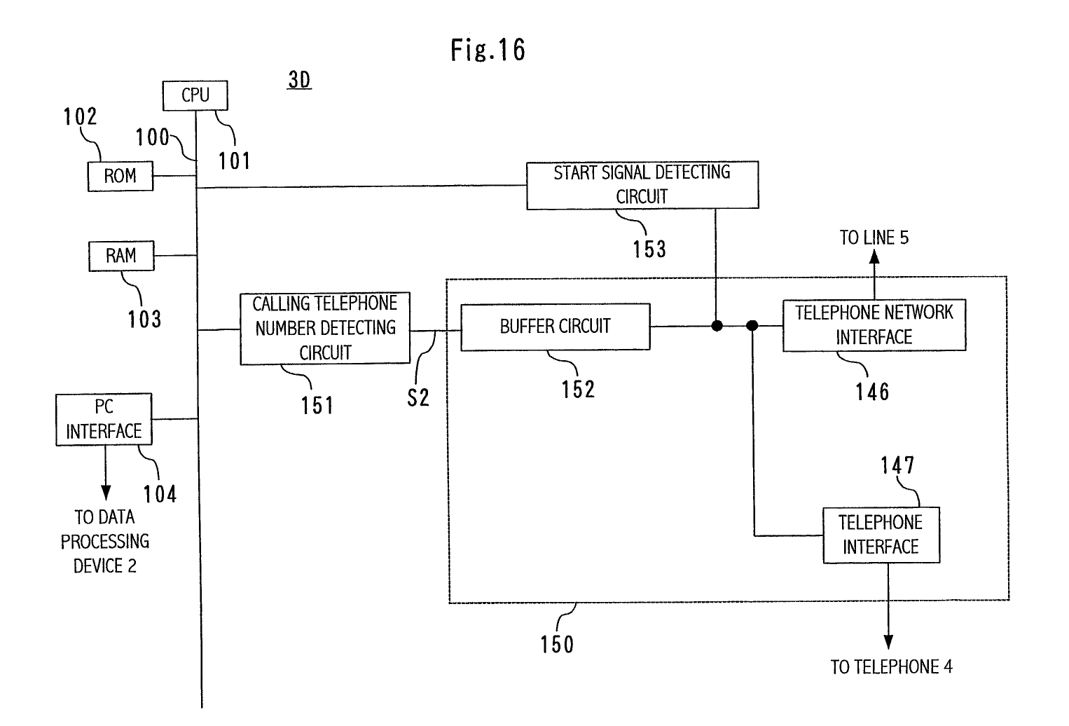

In FIG. 16, the CPU 101, the ROM 102, the RAM 103, the bus 100, the PC interface 104, the telephone network interface 146, and the telephone interface 147 are the same as those explained with reference to FIG. 4. In addition, members having no relationship with the function and the operation of this embodiment are not shown in the figure.

The connection switching circuit 150 includes a buffer circuit 152. The buffer circuit 152 has a high input impedance, which is above one megohm for NTT specification, for example and does not affect the communication path between the telephone 4 and the line 5.

The calling telephone number detecting circuit 151 includes an A/D converter for converting the detected signal S2 that is outputted by the buffer circuit 152 into a digital signal. The output of the calling telephone number detecting circuit 151 is given to the CPU 101 or the RAM 103 via the bus 100. The CPU 101 obtains the calling telephone number by performing a software in accordance with the output of the calling telephone number detecting circuit 151 and memorizes the obtained calling telephone number in the RAM 103.

The start signal detecting circuit 153 detects the start signal that is included in the calling telephone number reception sequence and gives the output to the CPU 101 or the RAM 103 via the bus 100. The CPU 101 sets the operational flag that is related to the software for detecting the calling telephone number by detecting the start signal.

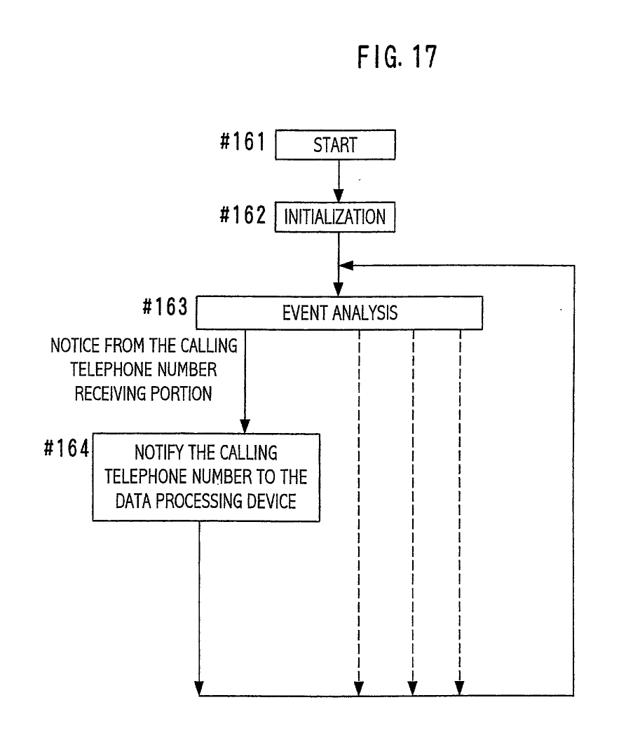

FIG. 17 shows an example of the operation A of the communication control device 3D. The content of FIG. 17 corresponds to claims 21 and 22.

In FIG. 17, when the process starts (#161), the communication control device 3D is initialized, i.e., resisters and variables inside the communication control device 3D are initialized (#162), so as to be the event waiting state (#163).

In this state, when the detected signal S2 is detected from the buffer circuit 152, the calling telephone number detecting portion 42 obtains the calling telephone number from the detected signal S2. When the calling telephone number is obtained, it is recognized by the event analysis and is notified to the PC interface 104. Then, the PC interface 104 informs the data processing device 2 of the calling telephone number (#164). Then, it returns to the event waiting state (#163).

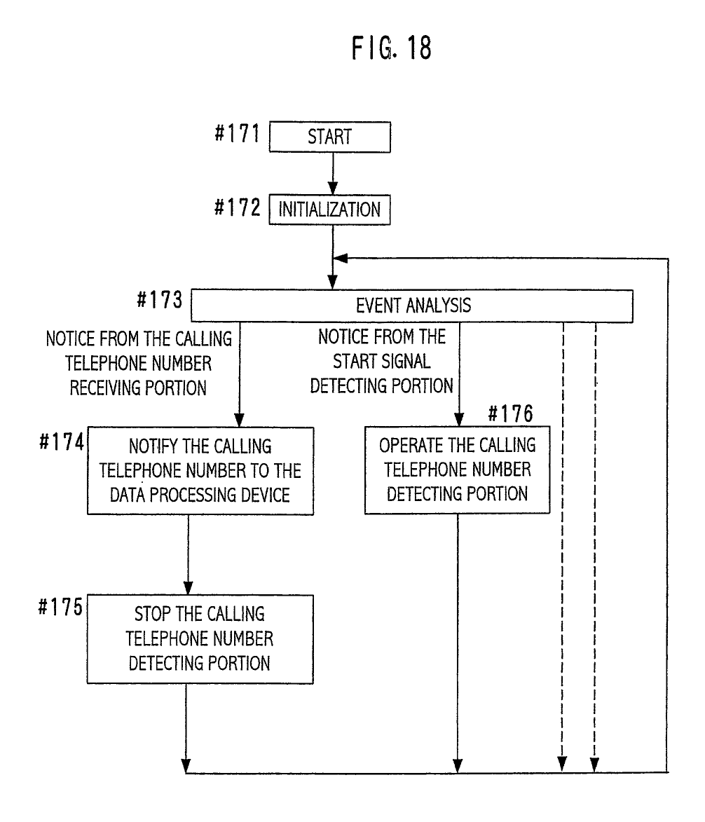

FIG. 18 shows an example of the operation B of the communication control device 3D. The content of FIG. 18 corresponds to claim 23.

Steps #171-174 of FIG. 18 are similar to Steps #161-164 of FIG. 17.

In the flowchart of FIG. 18, the calling telephone number detecting portion 42 starts the operation in accordance with the notice form the start signal detecting portion 43 (#176). In addition, after the calling telephone number is obtained and the PC interface 104 informs the data processing device 2 of the calling telephone number in Step #174, the calling telephone number detecting portion 42 is stopped (#175).

According to the communication control device 3D of this embodiment, the calling telephone number reception sequence is executed only by the telephone 4. The communication control device 3D obtains the calling telephone number in accordance with the detected signal S2 that is detected from the communication path via the signal detecting portion 41, without executing the calling telephone number reception sequence.

Therefore, the calling telephone number reception sequence is performed normally without a contention. Furthermore, the communication control device 3D can obtain the calling telephone number correctly. Thus, both the telephone 4 and the communication control device 3D can obtain the calling telephone number.

[Fifth Embodiment]

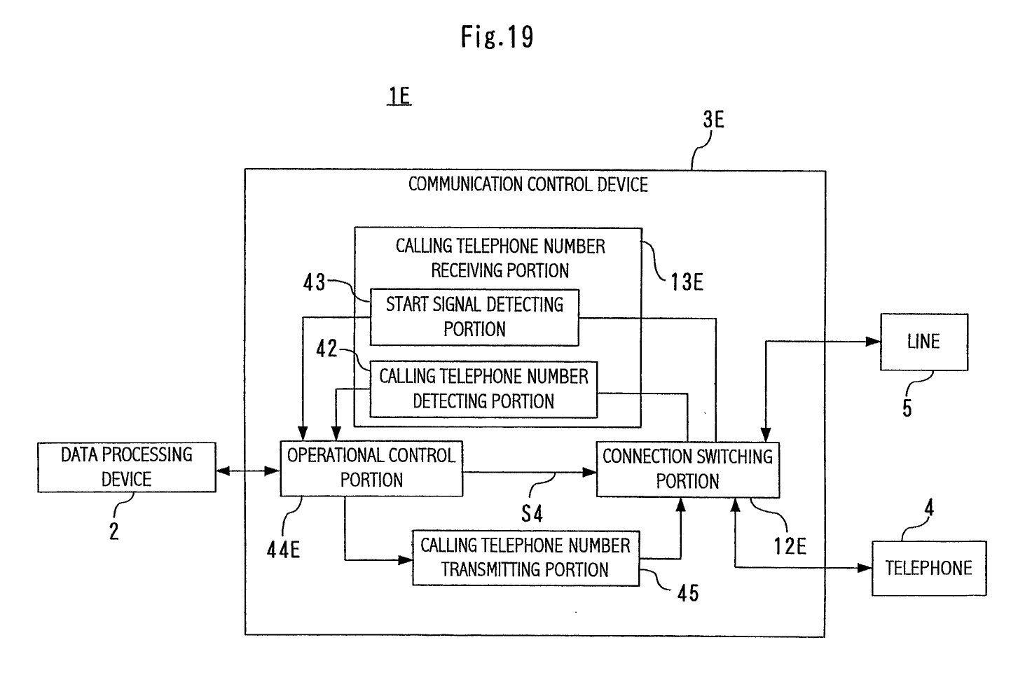

Next, a communication control device 3E according to a fifth embodiment of the present invention will be explained with reference to FIGS. 19-21.

In FIG. 19, the basic structure and function of the communication control device 3E are the same as the communication control device 3 explained with reference to FIG. 1.

The communication control device 3E includes a connection switching portion 12E, a calling telephone number receiving portion 13E, an operational control portion 44E, and a calling telephone number transmitting portion 45.

The connection switching portion 12E switches the connection between the telephone 4 and the line 5 or the calling telephone number transmitting portion 45. The calling telephone number receiving portion 13E, in the same way as the calling telephone number receiving portion 13D, executes the calling telephone number reception sequence between the line 5 and itself.

The calling telephone number transmitting portion 45, between this and the other terminal device, transmits the signal for making other terminal device execute the calling telephone number reception sequence. Namely, the calling telephone number transmitting portion 45 executes the procedure of the transmission side of the calling telephone number in the calling telephone number reception sequence. The necessary calling telephone number is obtained when the calling telephone number receiving portion 13E executes the calling telephone number reception sequence between the line 5 and itself. Namely, the calling telephone number obtained from the line 5 is transferred to the other terminal device by the calling telephone number transmitting portion 45.

When a call is received from the line 5, the operational control portion 44E controls the connection switching portion 12E using the control signal S4 so as to connect the line 5 with the calling telephone number receiving portion 13E for executing the calling telephone number reception sequence between the line 5 and itself. In addition, after obtaining the calling telephone number, it controls the connection switching portion 12E using the control signal S4 so as to connect the calling telephone number transmitting portion 45 with the telephone 4 for executing the calling telephone number reception sequence between the calling telephone number transmitting portion 45 and the telephone 4.

The operational control portion 44E includes a function of the connection switching means 25 of the second embodiment.

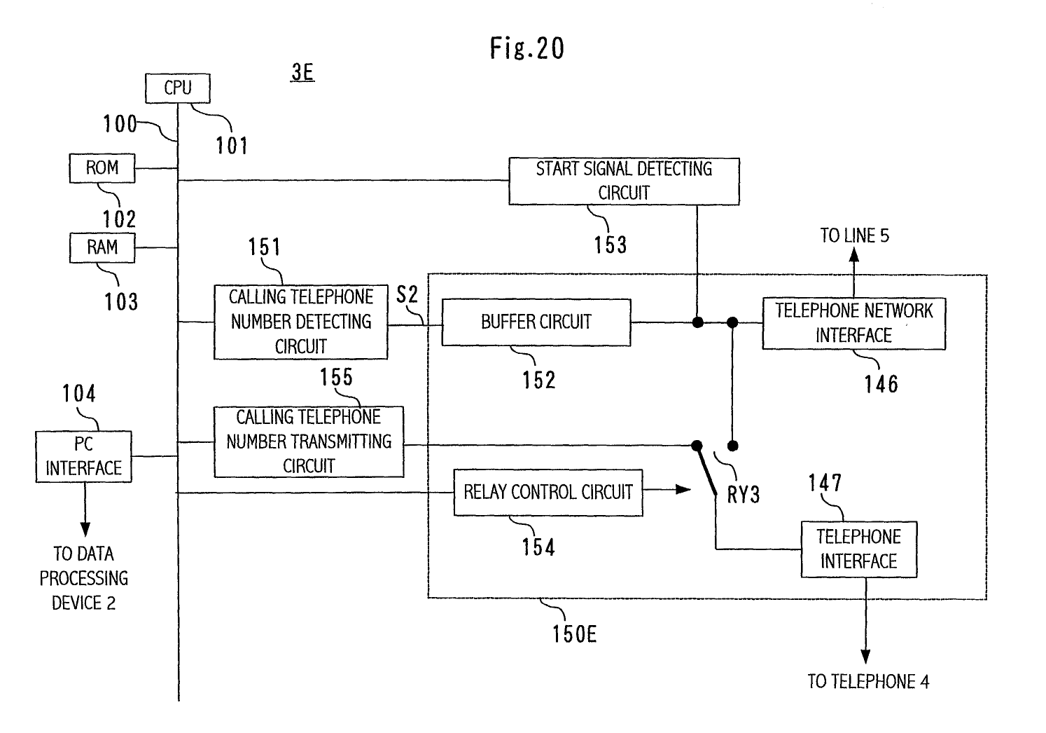

In FIG. 20, a connection switching circuit 150E includes a relay control circuit 154 and a relay RY3. The relay control circuit 154 controls the relay RY3 in accordance with a data signal from the bus 100. By the relay control circuit 154, the contact of the relay RY3 is switched so that the telephone interface 147 is connected with the calling telephone number transmitting circuit 155, or that the telephone interface 147 is connected with the telephone network interface 146.

The calling telephone number detecting circuit 151 executes the calling telephone number reception sequence between the line 5 and itself. The obtained calling telephone number is memorized in the RAM 103, or the like. The memorized calling telephone number is used by the calling telephone number transmitting circuit 155, which executes the calling telephone number reception sequence shown in FIG. 2 between the telephone 4 and itself by software execution of the CPU 101.

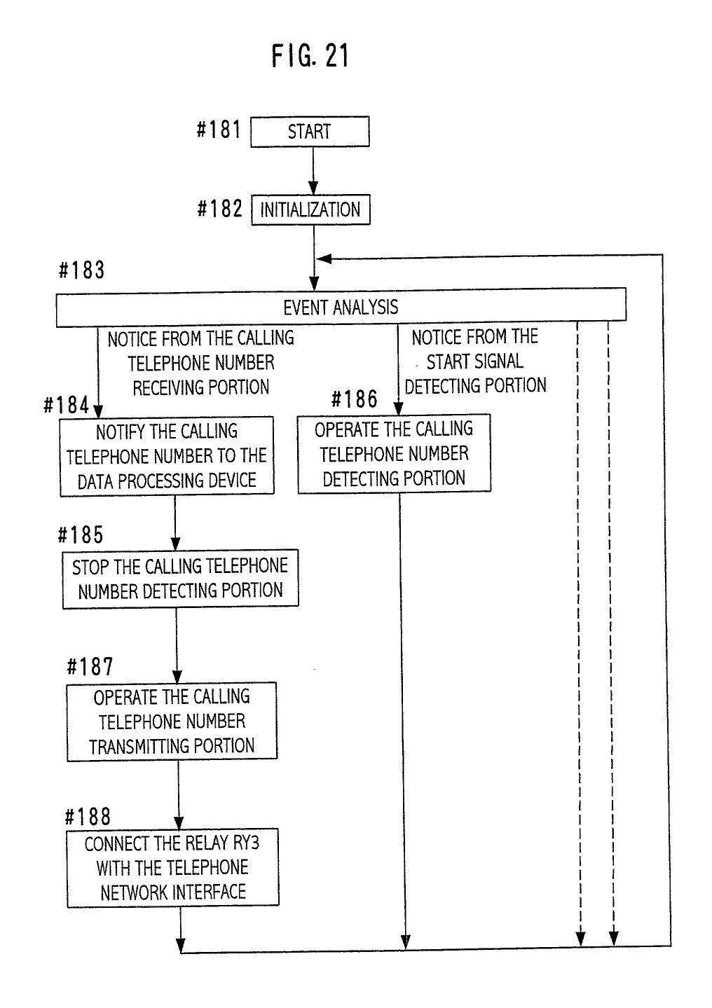

FIG. 21 shows an example of the processing operation of the communication control device 3E. The content of FIG. 21 corresponds to claims 26 and 27.

In FIG. 21, Steps #181-186 are similar to Steps #171-176 of FIG. 18. However, in Step #182 for the initialization, the relay RY3 is switched so that the calling telephone number transmitting circuit 155 is connected with the telephone interface 147.

In the flowchart of FIG. 21, the calling telephone number reception sequence is executed in Step #186. In Step #185, after stopping the operation of the calling telephone number detecting portion 42, the calling telephone number transmitting portion 45 is activated so that the calling telephone number reception sequence is executed between the telephone 4 and itself (#187).

When the execution of the calling telephone number reception sequence between the calling telephone number transmitting portion 45 and the telephone 4 is completed, the relay RY3 is switched so that the telephone interface 147 is connected with the telephone network interface 146 (#188). Thus, the telephone 4 is connected with the line 5, and a communication is performed between them. When the communication between the telephone 4 and the line 5 is finished, the relay RY3 is returned to the initial state.

According to the communication control device 3E of this embodiment, the calling telephone number reception sequence is executed only by the communication control device 3E between the line 5 and itself. Thus, the communication control device 3E obtains the calling telephone number.

The telephone 4 executes the calling telephone number reception sequence between the communication control device 3E and itself. On this occasion, the previously obtained calling telephone number is used. Thus, the telephone 4 obtains the calling telephone number.

Therefore, the calling telephone number reception sequence is executed normally without a contention. In addition, both the telephone 4 and the communication control device 3E can obtain the calling telephone number.

[Sixth Embodiment]

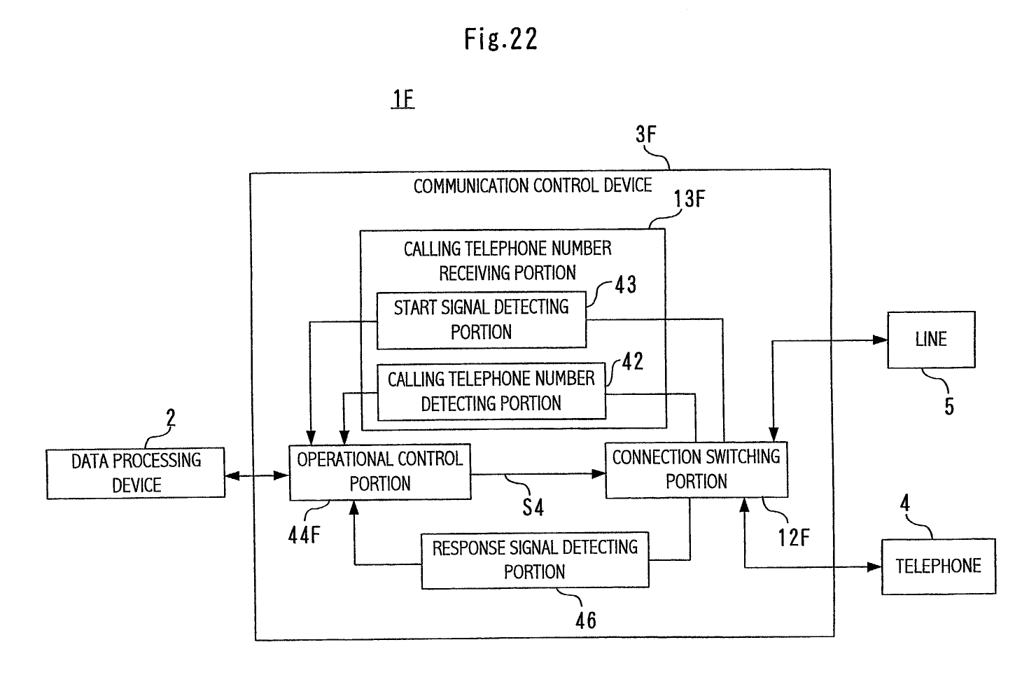

Next, a communication control device 3F according to a sixth embodiment of the present invention will be explained with reference to FIGS. 22-24.

In FIG. 22, the basic structure and function of the communication control device 3F are the same as the communication control device 3 explained with reference to FIG. 1.

The communication control device 3F includes a connection switching portion 12F, a calling telephone number receiving portion 13F, an operational control portion 44F, and a response signal detecting portion 46.

The response signal detecting portion 46 detects a primary response signal that is sent from the other terminal device when the calling telephone number reception sequence is executed between the line 5 and the other terminal device. The primary response signal is an off-hook signal as explained with reference to FIG. 2. A direct current detecting circuit is used as the response signal detecting portion 46.

In this embodiment, the primary response signal is detected if the telephone 4 supports the caller ID service, but the primary response signal is not detected if the telephone 4 does not support the caller ID service, or if the telephone 4 is not connected. If the primary response signal is not detected in a predetermined period of time from the start signal, the connection of the connection switching portion 12F is switched, and the calling telephone number receiving portion 13F executes the calling telephone number reception sequence between the line 5 and itself.

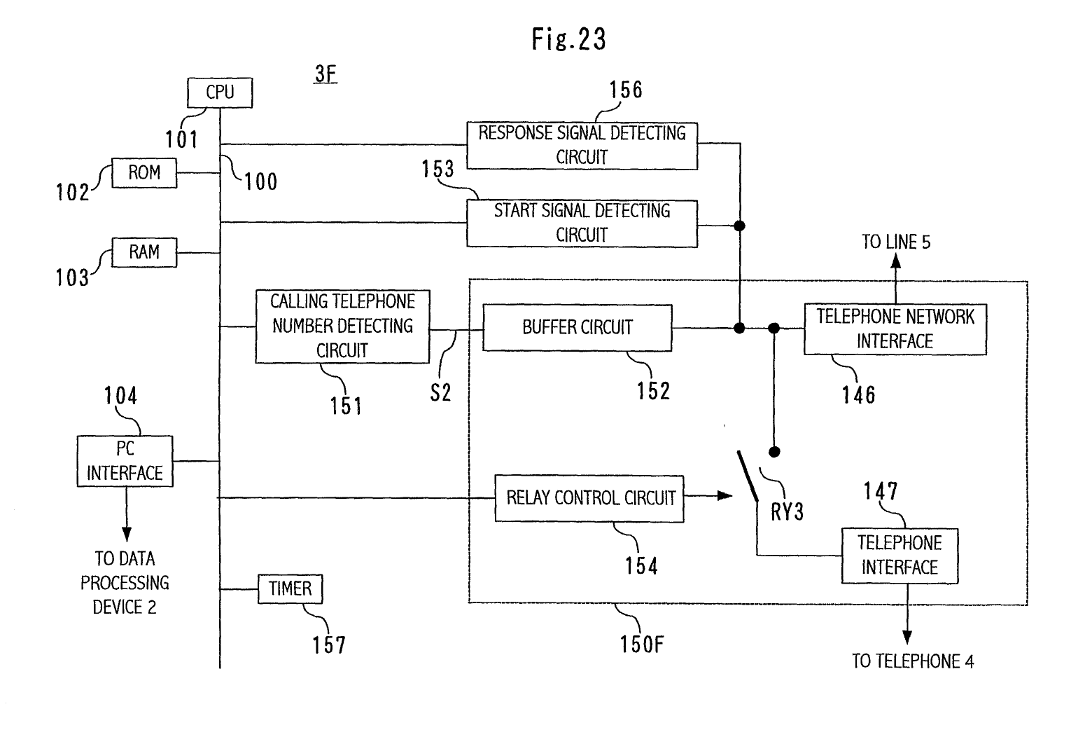

In FIG. 23, the response signal detecting circuit 156 detects the primary response signal in accordance with the signal from the connection switching circuit 150F and outputs the signal to the bus 100. A timer 157 counts the set time and output a timeout signal when the time is over. The timer 157 is set to approximately 3-4 seconds for the NTT specification, for example.

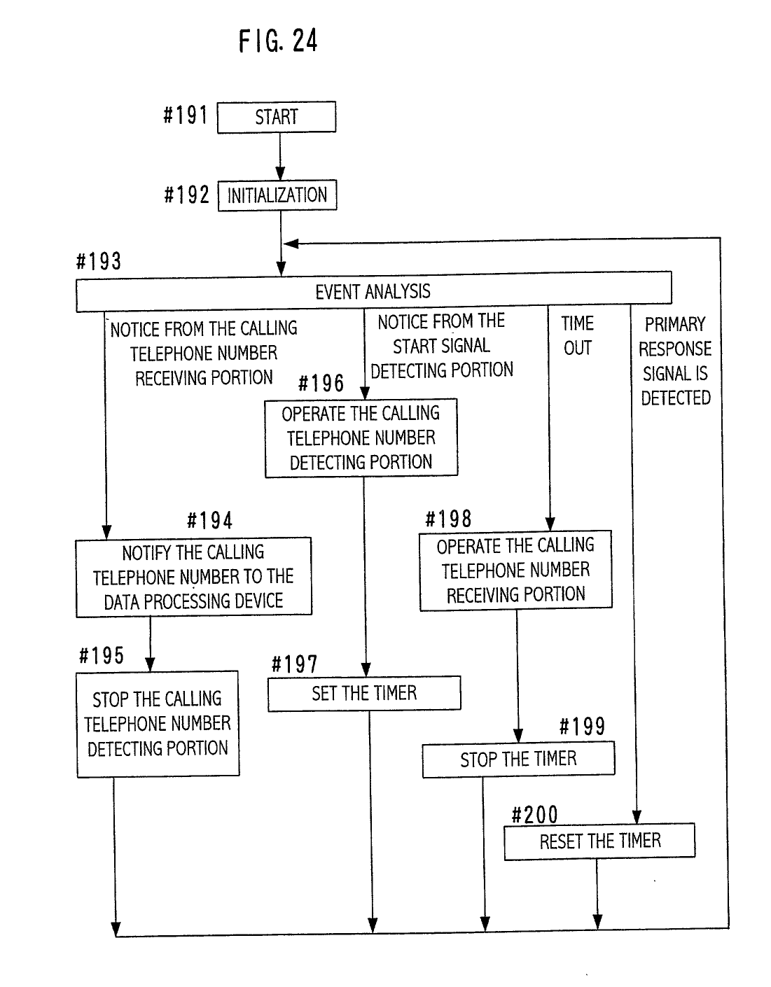

FIG. 24 shows an example of the processing operation of the communication control device 3F. The content of FIG. 24 corresponds to claims 24 and 25.

In FIG. 24, Steps #191-196 are similar to Steps #171176 of FIG. 18. However, in Step #192 for the initialization, the relay RY3 is switched so that the telephone network interface 146 is connected with the telephone interface 147.

In the flowchart of FIG. 24, the operation of the calling telephone number detecting portion 42 is started in Step #196, and then the timer 157 is set to start (#197). When the timer 157 becomes over, the calling telephone number receiving portion 13F is started so as to execute the calling telephone number reception sequence (#198). Then, the timer 157 is stopped (#199). If the primary response signal is detected in the set time of the timer 157, the timer 157 is reset (#200).

According to the communication control device 3F of this embodiment, if the other terminal device is not connected with the communication control device 3F, or if the connected terminal device does not support the caller ID service, the calling telephone number reception sequence is normally executed between the line 5 and the communication control device 3F, so that the calling telephone number can be obtained.

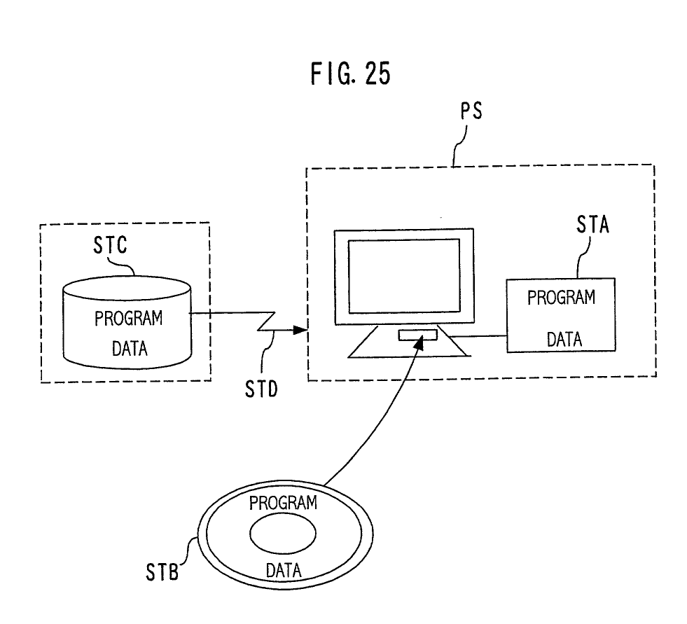

FIG. 25 is a diagram showing a form of a recording medium ST of a program for performing the method according to the present invention.

As shown in FIG. 25, a memory device STA such as a main memory, a RAM, a ROM, or a hard disk equipped to a processing device PS, a portable medium STB such as a CD-ROM, a floppy disk or a magneto-optical disk, a network medium STC such as a server or a DASD that is connected via a network or a communication line STD, or a communication line STD itself can be utilized as a recording medium ST.

If the recording medium ST is a portable medium STB, the program is read out by a driving device that corresponds to the kind of the portable medium STB and is stored in the memory device STA of the processing device PS or is loaded on the main memory, so as to be executed by the CPU. If the recording medium ST is the network medium STC, the program is downloaded via the communication line STD into the memory device STA, or is transmitted appropriately for execution. The program can be supplied so as to work under the environment of various operating systems, platforms, a system environment or a network environment. The program that is stored in the recording medium can be provided as one of the functions of the device driver for a modem, for example.

### INDUSTRIAL AVAILABILITY

As explained above, the communication control method, the terminal device and the recording medium for the calling telephone number notice according to the present invention enable plural terminal devices that are connected to the telephone line to receive the call with the calling telephone number from the telephone line without a contention and to obtain the calling telephone number, so as to be useful for a communication and electronics industries.

1. A communication control method for plural terminal devices that are connected to a telephone line to receive a call with a calling telephone number from the telephone line without a contention, the method comprising the steps of:
providing a master terminal device that is a terminal device connected directly to the telephone line with means for setting whether or not a calling telephone number reception sequence is executed in the terminal device;
executing the calling telephone number reception sequence in the master terminal device, and setting the disconnected state between the telephone line and the other terminal device, if it is set that the calling telephone number reception sequence is to be executed in the master terminal device; and
connecting the telephone line with the other terminal device without executing the calling telephone number reception sequence in the master terminal device if it is set that the calling telephone number reception sequence is not to be executed in the master terminal device, so as to execute the calling telephone number reception sequence by the other connected terminal device.

2. The communication control method for the calling telephone number delivery according to claim 1, wherein the master terminal device sets the disconnected state between the other terminal device and the telephone line during a reception waiting state.

3. The communication control method for the calling telephone number delivery according to claim 1, wherein the master terminal device connects the other terminal device with the telephone line when detecting the off-hook of the other terminal device at the reception waiting state.

4. A communication control method for a calling telephone number delivery for connecting a telephone that is connected to a communication control device to a telephone line, the method comprising the steps of:
providing connection switching means for making or breaking a communication path between the telephone and the telephone line and means for detecting the off-hook of the telephone; and
making the communication path between the telephone and the telephone line when detecting the off-hook of the telephone.

5. A terminal device that is connected to a telephone line, comprising:
setting means for setting whether or not a calling telephone number reception sequence is to be executed in the terminal device;
connecting means for connecting the telephone line to the terminal device or to the other terminal device in accordance with the content of setting by the setting means; and
calling telephone number receiving means for executing the calling telephone number reception sequence in accordance with the content of setting by the setting means.

6. A communication control device for connecting a common telephone line to a telephone and to a data processing device, comprising:
calling telephone number detecting means for detecting a calling telephone number from the telephone line;
connection switching means for making and breaking connection between the telephone and the telephone line; and
connection switching control means for controlling the connection switching means, wherein
the communication control device sets a disconnected state between the telephone and the telephone line using the connection switching control means and the connection switching means when the data processing device is in the operating state and when the calling telephone number detecting means is in the calling telephone number reception waiting state.

7. The communication control device according to claim 6, comprising hook state detecting means for detecting on-hook or off-hook of the telephone, wherein when the hook state detecting means detects the off-hook, and when the calling telephone number detecting means is in the calling telephone number reception waiting state, the connection switching control means and the connection switching means set the telephone and the telephone line in the connecting state.

8. The communication control device according to claim 6 or 7, wherein if the calling telephone number detecting means is not in the calling telephone number reception waiting state, the connection switching control means and the connection switching means set the telephone and the telephone line in the connecting state.

9. The communication control device according to any one of claims 6 to 8, wherein when the data processing device finishes the operation, the connection switching control means and the connection switching means set the telephone and the telephone line in the connecting state.

10. The communication control device according to any one of claims 6 to 9, wherein when the calling telephone number detecting means have detected the calling telephone number, the connection switching control means and the connection switching means set the telephone and the telephone line in the connecting state.

11. The communication control device according to any one of claims 6 to 10, comprising call detecting means for detecting a call from the telephone line, wherein when the call detecting means detect a call and when the command from the data processing device is the non-connection command, the connection switching control means and the connection switching means set the telephone and the telephone line in the disconnecting state.

12. The communication control device according to any one of claims 6 to 11, comprising call detecting means for detecting a call from a telephone line, hook state detecting means for detecting on-hook or off-hook of the telephone, and timer means for detecting a predetermined time, wherein if the hook state detecting means detect the on-hook and if the timer means detect the predetermined time under the set condition where the timer means are reset when the call detecting means detect a call, the connection switching control means and the connection switching means set the telephone and the telephone line in the disconnected state.

13. The communication control device according to any one of claims 6 to 12, comprising call detecting means for detecting a call from a telephone line, hook state detecting means for detecting on-hook or off-hook of the telephone, and timer means for detecting a predetermined time, wherein if the hook state detecting means detect the off-hook and if the timer means detect the predetermined time under the set condition where the timer means are reset when the call detecting means detect a call, the connection switching control means and the connection switching means set the telephone and the telephone line in the connecting state.

14. A communication control device that is connected to a telephone line, comprising:
connection switching means for making or breaking a communication path between a telephone and the telephone line;
means for detecting off-hook of the telephone; and
communication path control means for making a communication path between the telephone and the telephone line when detecting the off-hook of the telephone.

15. A communication control device that is connected to a telephone line, comprising:
connection switching means for making or breaking a communication path between a telephone and the telephone line;
means for detecting on-hook of the telephone; and
communication path control means for breaking a communication path between the telephone and the telephone line when detecting the on-hook of the telephone.

16. A communication control device that is connected to a telephone line, comprising:
connection switching means for making or breaking a communication path between a telephone and the telephone line;
means for detecting off-hook and on-hook of the telephone; and
communication path control means for making a communication path between the telephone and the telephone line when detecting the off-hook of the telephone upon power-on or reset, and for breaking the communication path between the telephone and the telephone line when detecting the on-hook of the telephone.

17. A communication control device that is connected to a telephone line, comprising:
connection switching means for making or breaking a communication path between a telephone and the telephone line as well as between a data processing device and a line;
means for detecting off-hook of the telephone; and
communication path control means for making a communication path between the telephone line and the data processing device at a call so that the data processing device can receive the call, and for making the communication path between the telephone and the telephone line when detecting the off-hook of the telephone so that the telephone can be used.

18. A communication control device that is connected to a telephone line, comprising:
connection switching means for making or breaking a communication path between a telephone and the telephone line as well as between a data processing device and the telephone line;
means for detecting off-hook and on-hook of the telephone; and
communication path control means for making a communication path between the telephone line and the data processing device at a call so that the data processing device can receive the call, and for making the communication path between the telephone and the telephone line when data processing device becomes a power-saving mode so that the telephone can receive the call.

19. A communication control device that is connected to a telephone line, comprising:
connection switching means for making or breaking a communication path between a telephone and the telephone line as well as between a data processing device and the telephone line;
communication path control means for making a communication path between the telephone line and the data processing device at a call so that the data processing device can receive the call, and for issuing periodically a notice for inquiring of the data processing device about its operational state, and for making the communication path between the telephone line and the telephone when a response to the notice is not received in a predetermined time.

20. A communication control method for plural terminal devices that are connected to a telephone line to receive a call with a calling telephone number from the telephone line without a contention, the method comprising the steps of:
providing a master terminal device that is a terminal device connected directly to the telephone line with connecting means for transmitting a calling telephone number reception sequence that is executed between the telephone line and the other terminal device;
monitoring the calling telephone number reception sequence in the terminal device during execution of the calling telephone number reception sequence between the telephone line and the other terminal device, so as to obtain the calling telephone number.

21. A terminal device that is connected to a telephone line, comprising:
connecting means for connecting the telephone line with the other terminal device and for detecting a signal that is transmitted between them so as to output the detected signal; and
monitoring means for monitoring the calling telephone number reception sequence that is executed between the telephone line and the other terminal device so as to obtain the calling telephone number in accordance with the detected signal.

22. The terminal device according to claim 21, wherein the connecting means include a buffer having a high input impedance, through which the detected signal is outputted.

23. The terminal device according to claim 21 or 22, comprising start signal detecting means for detecting a start signal of a calling telephone number reception sequence that is executed between the telephone line and the other terminal device in accordance with the detected signal, wherein the monitoring means start the monitoring operation when the start signal is detected.

24. The terminal device according to claim 23, comprising primary response signal detecting means for detecting a primary response signal of a calling telephone number reception sequence that is executed between the telephone line and the other terminal device in accordance with the detected signal, and calling telephone number receiving means for executing the calling telephone number reception sequence between the telephone line and itself, wherein the calling telephone number receiving means executes the calling telephone number reception sequence between the telephone line and itself if the primary response signal is not detected when the calling telephone number reception sequence is executed between the telephone line and the other terminal device.

25. The terminal device according to claim 24, wherein the calling telephone number reception sequence is executed when the primary response signal is not detected in a period from the detection of the start signal until the set time passes.

26. A communication control method for plural terminal devices that are connected to a telephone line to receive a call with a calling telephone number from the telephone line without a contention, the method comprising the steps of:
executing a calling telephone number reception sequence between a master terminal device and the telephone line, the master terminal being a terminal device that is connected directly to the telephone line, so as to obtain a calling telephone number;
memorizing the obtained calling telephone number;
executing the calling telephone number reception sequence between the master terminal device and the other terminal device in accordance with the memorized calling telephone number; and
transmitting the memorized calling telephone number to the other terminal device.

27. A terminal device that is connected to a telephone line, comprising:
calling telephone number receiving means for executing a calling telephone number reception sequence between the telephone line and itself;
memorizing means for memorizing the calling telephone number obtained by executing the calling telephone number reception sequence between the telephone line and itself;
calling telephone number transmission means for executing the calling telephone number reception sequence between the other terminal device and itself in accordance with the memorized calling telephone number; and
connection switching means for making or breaking a communication path between the telephone line and the other terminal device.

28. A computer readable recording medium storing a program for executing a communication control method for plural terminal devices that are connected to a telephone line to receive a call with a calling telephone number from the telephone line without a contention, the program controlling as follows:
when setting means that is provided in a master terminal device that is a terminal device connected directly to the telephone line set a calling telephone number reception sequence to be executed in the master terminal device, the calling telephone number reception sequence is executed in the master terminal device, and the connection between the telephone line and the other terminal device is set to a disconnected state; and
when the setting means set the calling telephone number reception sequence not to be executed in the master terminal device, the telephone line is connected to the other terminal device without executing the calling telephone number reception sequence in the master terminal device, and the other connected terminal device executes the calling telephone number reception sequence.

29. A computer readable recording medium storing a program for executing a communication control method for plural terminal devices that are connected to a telephone line to receive a call with a calling telephone number notice from the telephone line without a contention, the program controlling as follows:
when setting means that is provided in a master terminal device that is a terminal device connected directly to the telephone line set a calling telephone number reception sequence to be executed in the master terminal device, the calling telephone number reception sequence is executed in the master terminal device, and the connection between the telephone line and the other terminal device is set to a disconnected state;
when the setting means set the calling telephone number reception sequence not to be executed in the master terminal device, the telephone line is connected to the other terminal device without executing the calling telephone number reception sequence in the master terminal device, and the other connected terminal device executes the calling telephone number reception sequence; and
when the master terminal device is in a reception waiting state, the connection between the other terminal device and the telephone line is set to a disconnected state.

30. A computer readable recording medium storing a program for executing a communication control method for connecting a telephone that is connected to a communication control device to a line, wherein the program controls switching means for making or breaking a communication path between the telephone and the line so that the line is disconnected from the telephone at a normal operation, and that during the disconnection when the off-hook of the telephone is detected, the communication path between the line and the telephone is made.

31. A computer readable recording medium storing a program for executing a communication control method for connecting a telephone that is connected to a communication control device to a line, wherein the program controls switching means for making or breaking a communication path between the telephone and the line so that the communication path between the line and the data processing device is made at a call so as to set the state where the data processing device can receive the call, and that a notice is issued periodically for inquiring of the data processing device about its operational state, and that if a response to the notice is not received in a predetermined time, the communication path between the line and the telephone is made.

32. A computer readable recording medium storing a program for executing a communication control method for plural terminal devices that are connected to a telephone line to receive a call with a calling telephone number from the telephone line without a contention, wherein the program controls so that during the execution of the calling telephone number reception sequence between the telephone line and the other terminal device, the terminal device monitors the calling telephone number reception sequence so as to obtain a calling telephone number.

33. A computer readable recording medium storing a program for executing a communication control method for plural terminal devices that are connected to a telephone line to receive a call with a calling telephone number from the telephone line without a contention, wherein the program controls so that a master terminal device that is a terminal device connected directly to the telephone line executes a calling telephone number reception sequence between the telephone line and itself, memorizes the obtained calling telephone number, and executes the calling telephone number reception sequence between the other terminal device and the master terminal device in accordance with the memorized calling telephone number, so as to transfer the memorized calling telephone number to the other terminal device.

34. A computer readable recording medium storing a program for executing a communication control method for plural terminal devices that are connected to a telephone line to receive a call with a calling telephone number from the telephone line without a contention, the program controlling as follows:
when setting means that is provided in a master terminal device that is a terminal device connected directly to the telephone line set a calling telephone number reception sequence to be executed in the master terminal device, the calling telephone number reception sequence is executed in the master terminal device, and the connection between the telephone line and the other terminal device is set to a disconnected state;
when the setting means set the calling telephone number reception sequence not to be executed in the master terminal device, the telephone line is connected to the other terminal device without executing the calling telephone number reception sequence in the parent terminal device, and the other connected terminal device executes the calling telephone number reception sequence.

35. A computer program that is executable on a computer so that a system including the computer and the computer program performs the method according to any one of claims 1, 2, 3, 4, 20 or 26.

36. A computer program that can be loaded on a computer so that the programmed computer performs the method according to any one of claims 1, 2, 3, 4, 20 or 26.

37. A computer program product including a computer readable recording medium storing a computer program for a computer to execute the method according to any one of claims 1, 2, 3, 4, 20 or 26 upon the loading.
